(19) United States
(12) Patent Application Publication
(10) Pub. No.: US 2024/0259160 A1
(43) Pub. Date: Aug. 1, 2024

(54) FAST ANTENNA SWITCHING FOR SOUNDING REFERENCE SIGNALS

(71) Applicant: QUALCOMM Incorporated, San Diego, CA (US)

(72) Inventors: Ruiming ZHENG, Beijing (CN); Muhammad Sayed Khairy ABDELGHAFFAR, San Jose, CA (US); Yu ZHANG, San Diego, CA (US); Runxin WANG, San Diego, CA (US); Linhai HE, San Diego, CA (US)

(21) Appl. No.: 18/565,241

(22) PCT Filed: Jul. 30, 2021
(86) PCT No.: PCT/CN2021/109518

§ 371 Date: Nov. 29, 2023

(51) Int. Cl. H04L 5/00

(52) U.S. Cl. CPC H04L 5/0051

(57) ABSTRACT

Methods, systems, and devices for wireless communications are described. A base station may transmit configuration signaling such as radio resource control (RRC) signaling to a user equipment (UE) which indicates a number of sounding reference signal (SRS) resource sets and respective SRS resources within each of the SRS resource sets that may be used for channel estimation. The base station may subsequently transmit a control message such as a medium access control (MAC) control element (CE) to the UE, which indicates an activation status for at least one SRS resource within the SRS resource set. Basedon the indicated activation status for the at least one SRS resource, the UE may transmit one or more SRSs to the base station.

### CROSS REFERENCE

The present Application is a 371 national stage filing of International PCT Application No. PCT/CN2021/109518 by ZHENG et al. entitled “FAST ANTENNA SWITCHING FOR SOUNDING REFERENCE SIGNALS,” filed Jul. 30, 2021, which is assigned to the assignee hereof, and which is expressly incorporated by reference in its entirety herein.

### FIELD OF TECHNOLOGY

The following relates to wireless communications, including fast antenna switching for sounding reference signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may support communications using multiple bandwidth parts (BWPs). Each BWP may be associated with one or more sounding reference signal (SRS) resource sets including a group of SRS resources that the UE may use to transmit SRS signaling to a base station.

### SUMMARY

The described techniques relate to improved methods, systems, devices, and apparatuses that support fast antenna switching for sounding reference signals (SRSs). For example, the described techniques provide for a user equipment (UE) to use medium access control-control element (MAC-CE) or other control signaling to adjust or update SRS antenna switching configurations associated with a set of frequencies or bandwidth part (BWP) of a serving cell. A base station may configure the UE with one or more SRS resource sets via configuration signaling (e.g., radio resource control (RRC) signaling), where each SRS resource set includes a group of SRS resources associated with a BWP. To provide improved flexibility for configuring the SRS signaling, the base station may transmit a control message (e.g., a MAC-CE) to dynamically update the SRS configuration for the UE. The control message may reference or otherwise leverage information provided via the configuration signaling. For example, the control message may include an indication of an activation status for at least one SRS resource within the SRS resource set (e.g., where the SRS resource and the SRS resource set are identified in the MAC-CE based on corresponding identifiers ascribed thereto or otherwise indicated by the control signaling), and the UE may activate or deactivate one or more SRS resources as indicated by the control message. Based on receiving the control message and any associated activation status, the UE may transmit one or more SRSs to the base station. In some implementations, the control message may indicate whether additional SRS resources are being activated or deactivated by the control message. In some implementations, the control message may indicate a quantity of SRS switching groups, along with an indicator of a group of one or more SRS resource sets which are activated as part of the switching group.

A method for wireless communication is described. The method may include receiving configuration signaling that indicates a set of multiple SRS resource sets, each of the multiple SRS resource sets including a respective plurality of SRS resources, receiving a control message that indicates, for a SRS resource set of the set of multiple SRS resource sets, an activation status for a SRS resource within the SRS resource set, and transmitting one or more SRSs based on the activation status for the SRS resource within the SRS resource set.

An apparatus for wireless communication is described. The apparatus may include a processor, memory coupled with the processor, and instructions stored in the memory. The instructions may be executable by the processor to cause the apparatus to receive configuration signaling that indicates a set of multiple SRS resource sets, each of the multiple SRS resource sets comprising a respective plurality of SRS resources, receive a control message that indicates, for a SRS resource set of the set of multiple SRS resource sets, an activation status for a SRS resource within the SRS resource set, and transmit one or more SRSs based on the activation status for the SRS resource within the SRS resource set.

Another apparatus for wireless communication is described. The apparatus may include means for receiving configuration signaling that indicates a set of multiple SRS resource sets, each of the multiple of SRS resource sets including a respective plurality of SRS resources, means for receiving a control message that indicates, for a SRS resource set of the set of multiple SRS resource sets, an activation status for a SRS resource within the SRS resource set, and means for transmitting one or more SRSs based on the activation status for the SRS resource within the SRS resource set.

A non-transitory computer-readable medium storing code for wireless communication is described. The code may include instructions executable by a processor to receive configuration signaling that indicates a set of multiple SRS resource sets, each of the multiple SRS resource sets including a respective plurality of SRS resources, receive a control message that indicates, for a SRS resource set of the set of multiple SRS resource sets, an activation status for a SRS resource within the SRS resource set, and transmit one or more SRSs based on the activation status for the SRS resource within the SRS resource set.

Some examples of the method, apparatuses, and non-transitory computer-readable medium described herein may further include operations, features, means, or instructions for receiving, within the configuration signaling, an indication of a respective identifier for each of the set of multiple SRS resource sets and receiving, within the control message, an indication of one or more identifiers each corresponding to a respective SRS resource set, where the one or more identifiers include an identifier of the SRS resource set.

Some examples of the method, apparatuses, and non-transitory computer-readable medium described herein may further include operations, features, means, or instructions for receiving, within the control message, an indication of a respective activation status for each SRS resource within the SRS resource set, the respective activation status being either activated or deactivated.

In some examples of the method, apparatuses, and non-transitory computer-readable medium described herein, the indication of the respective activation status for each SRS resource within the SRS resource set includes a bitmap, each bit of the bitmap indicating the respective activation status for a corresponding SRS resource.

Some examples of the method, apparatuses, and non-transitory computer-readable medium described herein may further include operations, features, means, or instructions for receiving, within the control message, an indication of whether the control message may be to activate or deactivate one or more SRS resources.

Some examples of the method, apparatuses, and non-transitory computer-readable medium described herein may further include operations, features, means, or instructions for receiving, within the control message, for each of one or more SRS resource sets identified in the control message, a respective indication of whether the control message may be to activate or deactivate one or more SRS resources within a corresponding one of the one or more SRS resource sets.

Some examples of the method, apparatuses, and non-transitory computer-readable medium described herein may further include operations, features, means, or instructions for receiving, within the control message, for each of one or more activated SRS resources as indicated by the control message, a respective indication of a respective set of one or more antenna ports, where transmitting the one or more SRSs includes and transmitting, via each of the one or more activated SRS resources, a respective SRS using the respective set of one or more antenna ports for the activated SRS resource.

In some examples of the method, apparatuses, and non-transitory computer-readable medium described herein, the respective indication of the respective set of one or more antenna ports includes a bitmap, each bit of the bitmap indicating whether a corresponding antenna port may be included in the respective set of one or more antenna ports.

Some examples of the method, apparatuses, and non-transitory computer-readable medium described herein may further include operations, features, means, or instructions for receiving, within the control message, an indication of whether the control message may be for a normal uplink carrier or a supplementary uplink carrier.

Some examples of the method, apparatuses, and non-transitory computer-readable medium described herein may further include operations, features, means, or instructions for receiving, within the control message, an indication of a quantity of SRS resource sets subject to the control message.

Some examples of the method, apparatuses, and non-transitory computer-readable medium described herein may further include operations, features, means, or instructions for receiving, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set and receiving, within the control message, an indication of a quantity of activated SRS resources for each SRS resource set of the group of SRS resource sets, where the control message indicates the activation status for the SRS resource based on including the indication of the quantity of activated SRS resources for each SRS resource set of the group of SRS resource sets.

Some examples of the method, apparatuses, and non-transitory computer-readable medium described herein may further include operations, features, means, or instructions for receiving, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set; and receiving, within the control message, for each SRS resource set of the group of SRS resource sets, a respective indication of a quantity of activated SRS resources within a corresponding SRS resource set, where the control message indicates the activation status for the sounding reference signal resource based on including the respective indication of the quantity of activated SRS resources within the SRS resource set.

Some examples of the method, apparatuses, and non-transitory computer-readable medium described herein may further include operations, features, means, or instructions for receiving, within the configuration signaling, an indication of a respective identifier for each of a set of multiple SRS resource configurations, where the set of multiple SRS resource configurations each correspond to a respective set of one or more activated SRS resources being activated, receiving, within the control message, an indication of an identifier of the SRS resource set, and receiving, within the control message, for the SRS resource set, an indication of an identifier of a SRS resource configuration of the set of multiple SRS resource configurations, where the control message indicates the activation status for the SRS resource based on including the indication of the identifier of the SRS resource configuration.

Some examples of the method, apparatuses, and non-transitory computer-readable medium described herein may further include operations, features, means, or instructions for receiving, within the control message, an indication of a serving cell corresponding to the SRS resource set, an indication of a BWP corresponding to the SRS resource set, or both.

In some examples of the method, apparatuses, and non-transitory computer-readable medium described herein, the control message includes a medium access control-control element (MAC-CE).

A method for wireless communication is described. The method may include transmitting configuration signaling that indicates a set of multiple SRS resource sets and a respective set of SRS resources within each of the set of multiple SRS resource sets, transmitting a control message that indicates, for a SRS resource set of the set of multiple SRS resource sets, an activation status for a SRS resource within the SRS resource set, and receiving one or more SRSs based on the activation status for the SRS resource within the SRS resource set.

An apparatus for wireless communication is described. The apparatus may include a processor, memory coupled with the processor, and instructions stored in the memory. The instructions may be executable by the processor to cause the apparatus to transmit configuration signaling that indicates a set of multiple SRS resource sets and a respective set of SRS resources within each of the set of multiple SRS resource sets, transmit a control message that indicates, for a SRS resource set of the set of multiple SRS resource sets, an activation status for a SRS resource within the SRS resource set, and receive one or more SRSs based on the activation status for the SRS resource within the SRS resource set.

Another apparatus for wireless communication is described. The apparatus may include means for transmitting configuration signaling that indicates a set of multiple SRS resource sets and a respective set of SRS resources within each of the set of multiple SRS resource sets, means for transmitting a control message that indicates, for a SRS resource set of the set of multiple SRS resource sets, an activation status for a SRS resource within the SRS resource set, and means for receiving one or more SRSs based on the activation status for the SRS resource within the SRS resource set.

A non-transitory computer-readable medium storing code for wireless communication is described. The code may include instructions executable by a processor to transmit configuration signaling that indicates a set of multiple SRS resource sets and a respective set of SRS resources within each of the set of multiple SRS resource sets, transmit a control message that indicates, for a SRS resource set of the set of multiple SRS resource sets, an activation status for a SRS resource within the SRS resource set, and receive one or more SRSs based on the activation status for the SRS resource within the SRS resource set.

Some examples of the method, apparatuses, and non-transitory computer-readable medium described herein may further include operations, features, means, or instructions for transmitting, within the configuration signaling, an indication of a respective identifier for each of the set of multiple SRS resource sets and transmitting, within the control message, an indication of one or more identifiers each corresponding to a respective SRS resource set, where the one or more identifiers include an identifier of the SRS resource set.

Some examples of the method, apparatuses, and non-transitory computer-readable medium described herein may further include operations, features, means, or instructions for transmitting, within the control message, an indication of a respective activation status for each SRS resource within the SRS resource set, the respective activation status being either activated or deactivated.

Some examples of the method, apparatuses, and non-transitory computer-readable medium described herein may further include operations, features, means, or instructions for transmitting, within the control message, an indication of whether the control message may be to activate or deactivate one or more SRS resources.

Some examples of the method, apparatuses, and non-transitory computer-readable medium described herein may further include operations, features, means, or instructions for transmitting, within the control message, for each of one or more SRS resource sets identified in the control message, a respective indication of whether the control message may be to activate or deactivate one or more SRS resources within a corresponding one of the one or more SRS resource sets.

Some examples of the method, apparatuses, and non-transitory computer-readable medium described herein may further include operations, features, means, or instructions for transmitting, within the control message, for each of one or more activated SRS resources as indicated by the control message, a respective indication of a respective set of one or more antenna ports for use when transmitting a SRS via a corresponding one of the one or more SRS resources.

Some examples of the method, apparatuses, and non-transitory computer-readable medium described herein may further include operations, features, means, or instructions for transmitting, within the control message, an indication of whether the control message may be for a normal uplink carrier or a supplementary uplink carrier.

Some examples of the method, apparatuses, and non-transitory computer-readable medium described herein may further include operations, features, means, or instructions for transmitting, within the control message, an indication of a quantity of SRS resource sets subject to the control message.

Some examples of the method, apparatuses, and non-transitory computer-readable medium described herein may further include operations, features, means, or instructions for transmitting, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set and transmitting, within the control message, an indication of a quantity of activated SRS resources for each SRS resource set of the group of SRS resource sets, where the control message indicates the activation status for the SRS resource based on including the indication of the quantity of activated SRS resources for each SRS resource set of the group of SRS resource sets.

Some examples of the method, apparatuses, and non-transitory computer-readable medium described herein may further include operations, features, means, or instructions for transmitting, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set and transmitting, within the control message, for each SRS resource set of the group of SRS resource sets, a respective indication of a quantity of activated SRS resources within a corresponding SRS resource set, where the control message indicates the activation status for the sounding reference signal resource based on including the respective indication of the quantity of activated SRS resources within the SRS resource set.

Some examples of the method, apparatuses, and non-transitory computer-readable medium described herein may further include operations, features, means, or instructions for transmitting, within the configuration signaling, an indication of a respective identifier for each of a set of multiple SRS resource configurations, where the set of multiple SRS resource configurations each correspond to a respective set of one or more activated SRS resources being activated, transmitting, within the control message, an indication of an identifier of the SRS resource set, and transmitting, within the control message, for the SRS resource set, an indication of an identifier of a SRS resource configuration of the set of multiple SRS resource configurations, where the control message indicates the activation status for the SRS resource based on including the indication of the identifier of the SRS resource configuration.

In some examples of the method, apparatuses, and non-transitory computer-readable medium described herein, the control message includes a MAC-CE.

### BRIEF DESCRIPTION OF THE DRAWINGS

FIG. 1 illustrates an example of a wireless communications system that supports fast antenna switching for sounding reference signals (SRSs) in accordance with aspects of the present disclosure.

FIG. 2 illustrates an example of a wireless communications system that supports fast antenna switching for SRSs in accordance with aspects of the present disclosure.

FIGS. 3A, 3B, and 3C illustrate example MAC-CE configurations that support fast antenna switching for SRSs in accordance with aspects of the present disclosure.

FIG. 4 illustrates an example of a MAC-CE configuration that supports fast antenna switching for SRSs in accordance with aspects of the present disclosure.

FIG. 5A, 5B, and 5C illustrates an example MAC-CE configurations that support fast antenna switching for SRSs in accordance with aspects of the present disclosure.

FIG. 6 illustrates an example of a process flow that supports fast antenna switching for SRSs in accordance with aspects of the present disclosure.

FIGS. 7 and 8 show block diagrams of devices that support fast antenna switching for SRSs in accordance with aspects of the present disclosure.

FIG. 9 shows a block diagram of a communications manager that supports fast antenna switching for SRSs in accordance with aspects of the present disclosure.

FIG. 10 shows a diagram of a system including a device that supports fast antenna switching for SRSs in accordance with aspects of the present disclosure.

FIGS. 11 and 12 show block diagrams of devices that support fast antenna switching for SRSs in accordance with aspects of the present disclosure.

FIG. 13 shows a block diagram of a communications manager that supports fast antenna switching for SRSs in accordance with aspects of the present disclosure.

FIG. 14 shows a diagram of a system including a device that supports fast antenna switching for SRSs in accordance with aspects of the present disclosure.

FIGS. 15 through 19 show flowcharts illustrating methods that support fast antenna switching for SRSs in accordance with aspects of the present disclosure.

### DETAILED DESCRIPTION

In some wireless communications systems, a user equipment (UE) may transmit one or more reference signals (such as sounding reference signals (SRS)) to a base station for performing channel estimation and maintaining communications quality over a corresponding frequency region or bandwidth part (BWP). The base station may configure the UE with one or more SRS resource sets which each include a group of SRS resources that the UE may use to transmit SRS signaling to the base station. Different UEs present in the wireless communications system may have different SRS capabilities such as, for example, being capable of concurrently transmitting different quantities of SRSs, transmitting each SRS using different quantities of antenna ports, transmitting SRSs using different quantities of SRS resources, etc.

As UE capabilities increase, for example, as UEs are able to concurrently transmit greater quantities of SRSs, transmit SRSs using greater quantities of antenna ports, or transmit SRSs using greater quantities of SRS resources, a UE may use less than its full capabilities in some operating scenarios (e.g., in some channel conditions, a base station may be able to sufficiently estimate uplink channel quality for the UE even if the UE does not utilize its full SRS capability). Additionally or alternatively, full use of a UE's capabilities may consume an undesirable amount of network resources, consume an undesirable amount of power, or both. In some systems, however, SRS antenna configurations may be fixed within a BWP once signaled via RRC signaling, which may lead to inefficiencies and reduced flexibility. For example, although a base station may be able to use RRC signaling to configure a UE to have different SRS configurations for different BWPs, the base station may not thereafter be able to adapt or change the SRS configuration within a given BWP (e.g., other than by further RRC signaling).

To provide a more flexible and dynamic configuration for SRS signaling, a base station may use medium access control (MAC) control element (CE) signaling to adapt (e.g., adjust or update) the SRS configuration for a UE within a BWP. For example, the MAC-CE may indicate an SRS resource set cell ID and BWP ID, along with an indication of which SRS resources within one or more SRS resource sets are activated or deactivated. The base station may transmit (e.g., prior to such a MAC-CE message) RRC signaling to configure one or more SRS resource sets and which SRS resources are included in each SRS resource set. For example, the RRC signaling may assign or otherwise indicate various identifiers corresponding to the configured SRS resource sets and the SRS resources therein, and a subsequent MAC-CE may identify SRS resource sets or SRS resources whose configuration is being altered by the MAC-CE (e.g., that are being activated or deactivated) using identifiers as previously assigned via the RRC signaling. For example, a subsequent MAC-CE may include an identifier (e.g., an SRS Resource Set ID) of each SRS resource set whose configuration is to be adjusted, along with an indication of an activation status for each SRS resource within an identified SRS resource set (e.g., for each SRS resource, an indication of whether the SRS resource is activated or deactivated, such as through a bitmap in which each bit indicates the activation status of a respective SRS resource).

In some examples, the MAC-CE may include an activation/deactivation (A/D) indicator that explicitly indicates whether the MAC-CE is activating additional SRS resources or deactivating additional SRS resources within an indicated SRS resource set. A MAC-CE may include one A/D indicator applicable to each SRS resource set identified in the MAC-CE, or a MAC-CE may include multiple A/D indicators each applicable to a respective SRS resource set identified in the MAC-CE. In some examples, for each SRS indicated as activated by a MAC-CE, the MAC-CE may indicate a set of one or more antenna ports the UE is to use when transmitting on the activated SRS resource (e.g., the MAC-CE may include, for each activated SRS resource, a respective bitmap in which ach bit indicates the activation status of a respective antenna port).

In some examples, RRC signaling may configure a set of SRS switching groups, where an SRS switching group may be a group of one or more SRS resource sets, or where an SRS switching group may be a group of one or more activated SRS resources within an SRS resource set. Where an SRS switching group is a group of one or more SRS resource sets, a subsequent MAC-CE may indicate an identifier of the group of one or more SRS resource sets whose configuration is being adapted along with an indication of how many SRS resources are activated within each SRS resource set of the SRS switching group (e.g., a single quantity applicable to all SRS resource sets of the SRS switching group, or a respective quantity for each SRS resource set of the SRS switching group. Where an SRS switching group is a group of activated SRS resources, a subsequent MAC-CE may indicate one or more SRS resource sets along with a corresponding SRS switching group for each of the one or more SRS resource sets. Accordingly, in an identified SRS resource set, SRS resources corresponding to the indicated SRS switching group may be activated.

Aspects of the disclosure are initially described in the context of wireless communications systems. Aspects of the disclosure are further illustrated by and described with reference to apparatus diagrams, system diagrams, example MAC-CE configurations, a process flow, and flowcharts that relate to fast antenna switching for SRSs. Further, though certain examples may be described herein with reference to MAC-CE control messages, it is to be understood that this is just one example of a type of control message that may be used consistent with the teachings herein.

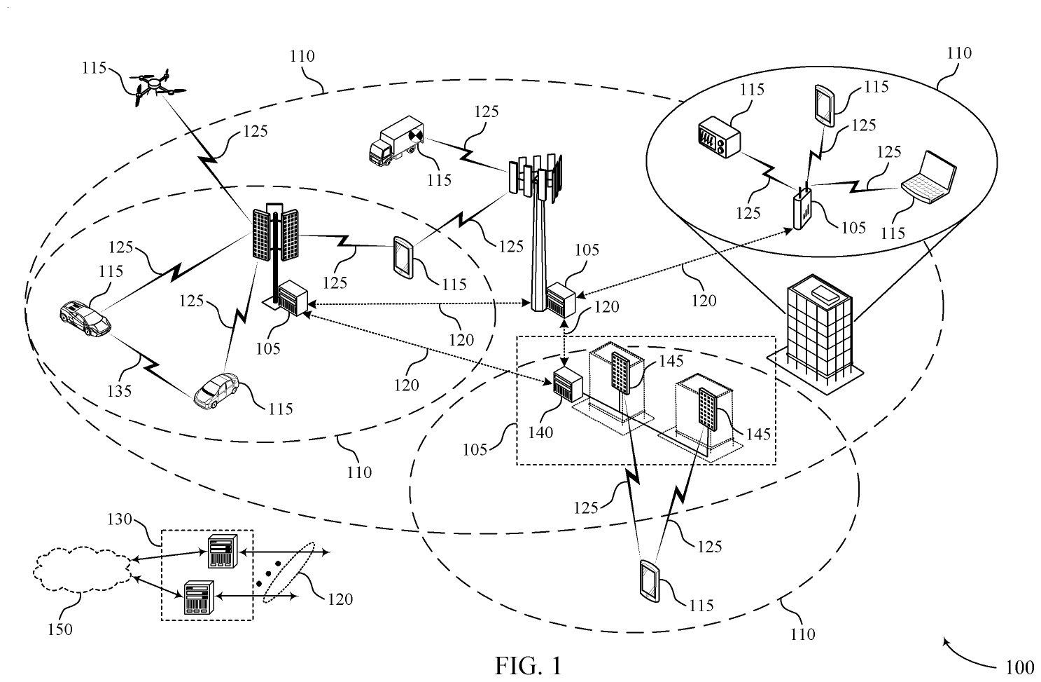

FIG. 1 illustrates an example of a wireless communications system 100 that supports fast antenna switching for SRSs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol periods (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

According to aspects described herein, wireless device such as a UE 115 may transmit one or more SRSs to a base station in accordance with an SRS configuration the UE 115 receives via RRC signaling. The base station 105 may configure the UE 115 with one or more SRS resource sets which each include a group of SRS resources associated with a BWP that the UE may use to transmit SRS signaling to the base station. In some systems, however, SRS antenna configurations may be fixed within a BWP once signaled via RRC signaling (e.g., may not be altered other than via additional RRC signaling), which may lead to inefficiencies and reduced flexibility. For example, although the base station 105 may be able to use RRC for initially configuring the UE 115 with SRS configurations for different BWPs, the base station 105 may not thereafter be able to adapt or change the SRS configuration within a given BWP (e.g., other than via additional RRC signaling).

To provide a more flexible configuration for SRS signaling, the wireless communications system 100 may support the use of MAC-CE signaling to dynamically adapt (e.g., adjust or update) the SRS configuration for a UE 115, including within a BWP. For example, the MAC-CE may indicate an SRS resource set cell ID and BWP ID, along with an indication of which SRS resources within one or more SRS resource sets are activated or deactivated. The base station may transmit RRC signaling to a UE 115 to configure the one or more SRS resource sets and which SRS resources are included in each SRS resource set, possibly along with associated identifiers that may be referenced (e.g., indicated) by subsequent MAC-CEs. A subsequent MAC-CE may include an identifier (e.g., an SRS Resource Set ID) of each SRS resource set whose configuration is to be adjusted, along with an indication of an activation status for each SRS resource within each identified SRS resource set.

In some examples, the MAC-CE may include an activation/deactivation (A/D) indicator that explicitly indicates whether the MAC-CE is activating additional SRS resources or deactivating additional SRS resources within one or more SRS resource sets. In some examples, RRC signaling may configure a set of SRS switching groups, where an SRS switching group may be a group of one or more SRS resource sets, or where an SRS switching group may be a group of one or more activated SRS resources within an SRS resource set. Where an SRS switching group is a group of one or more SRS resource sets, a subsequent MAC-CE may indicate an identifier of the group of one or more SRS resource sets whose configuration is being adapted along with an indication of how many SRS resources are activated within each SRS resource set of the SRS switching group (e.g., a single quantity applicable to all SRS resource sets of the SRS switching group, or a respective quantity for each SRS resource set of the SRS switching group). Accordingly, in an identified SRS resource set, SRS resources corresponding to the indicated SRS switching group may be activated.

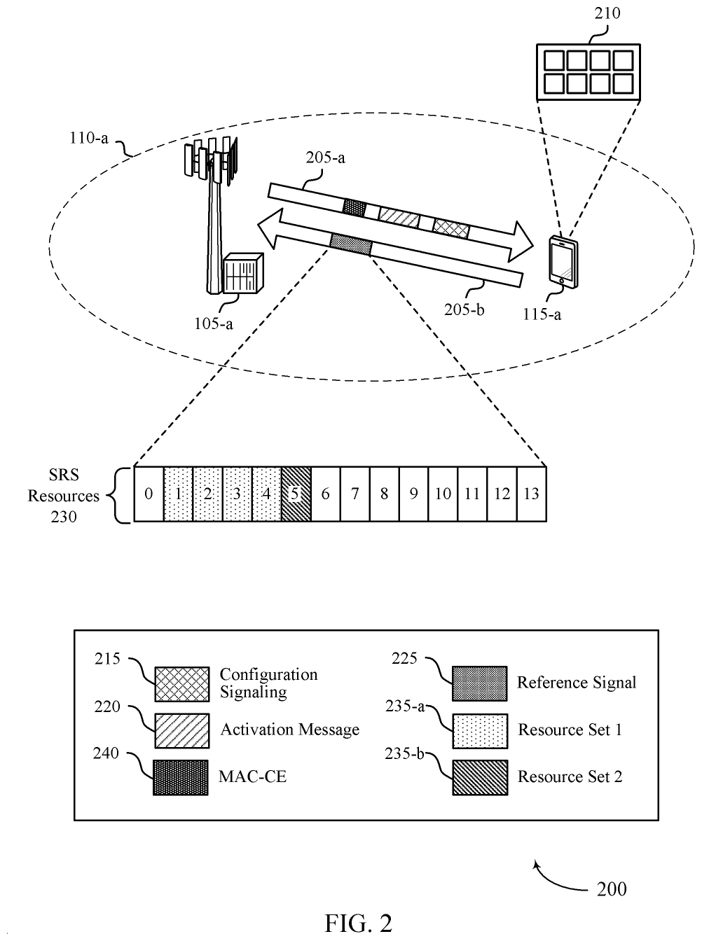

FIG. 2 illustrates an example of a wireless communications system 200 that supports fast antenna switching for SRSs in accordance with aspects of the present disclosure. In some examples, wireless communications system 200 may implement or be implemented by aspects of wireless communications system 100. For example, the wireless communications system 200 may include a UE 115-a and a base station 105-a, which may be examples of a UE 115 and a base station 105 as described with reference to FIG. 1.

The UE 115-a may communicate with the base station 105-a in a geographic coverage area 110-a supported by the base station 105-a. For example, the base station 105-a may transmit one or more downlink signals to the UE 115-a via a communications link 205-a (e.g., a downlink communications link) and the UE 115-a may transmit one or more uplink signals to the base station 105-a via a communications link 205-b (e.g., an uplink communications link). In some cases, the UE 115-a may be configured with a number of antenna ports 210 to use for both reception and transmission of downlink and uplink signals.

To increase communications efficiency and antenna diversity, the UE 115-a may perform SRS antenna switching, which may involve the UE 115-a transmitting one or more SRSs to the base station 105-a over one or more transmit antenna ports. In some cases, the base station 105-a may transmit configuration signaling 215 (e.g., RRC signaling) via the communications link 205-a that may indicate a configuration for the UE 115-a to use in selecting one or more SRS resource sets for a BWP for the UE 115-a. Each of the SRS resource sets may include reference signal resources (e.g., SRS resources) that correspond to one or more antenna ports 210 of the UE 115-a. The base station 105-a may configure the one or more SRS resource sets aperiodically, semi-persistently, or periodically for an active BWP of the UE 115-a. Additionally or alternatively, the base station 105-a may transmit an activation indication message 220 to the UE 115-a via the communications link 205-a. The activation message 220 may instruct the UE 115-a to activate at least one SRS resource set for reference signal transmissions using the active BWP.

The UE 115-a may transmit a reference signal (e.g., an SRS) over the activated SRS resource set using the active BWP and at least one antenna port 210 via the communications link 205-b. For example, the UE 115-a may use one or more SRS resources 230 to transmit an SRS to the base station 105-a. For example, the UE 115-a may use any of the SRS resources 230 (e.g., SRS resource 1 through SRS resource 13) to transmit an SRS to the base station 105-a. The SRS resources may be time-frequency resources of the active BWP, such as any of the symbol periods 1 to 13 of a slot, which may span at least a portion of the BWP. The base station 105-a may configure the UE 115-a with multiple SRS resources 230, which may be grouped into SRS resource sets 235 depending on the use case or usage type (e.g., antenna switching, beam management).

Each SRS resource set 235 may contain a set of SRS resources 230 over which the UE 115-a may transmit an SRS, such as a first resource set 235-a (e.g., including the SRS resource 1 through the SRS resource 4, although different numbers of SRS resources are possible for the first resource set 235-a) and a second resource set 235-b (e.g., including the SRS resource 5, although different numbers of SRS resources are possible for the second resource set 235-b). The UE 115-a and the base station 105-a may support SRS resources 230 that span 1, 2, 4, 8, or 12 adjacent symbols with up to a predefined number of ports (e.g., 8) per SRS resource. In some cases, up to a predefined number of SRS resource sets (e.g., 2 SRS resource sets) may be configured for SRS sounding with antenna switching. Each port of an SRS resource may be sounded in each symbol. In some cases, the UE 115-a may be configured to use a number of transmit antennas as well as a number of receive antennas. The UE 115-a may use up to the number of transmit antennas to transmit signals and may use up to the number of receive antennas to receive signals. In some cases, the number of transmit antennas versus the number of receive antennas may be given by xTyR, where x may be equal to the number of transmit antennas and y may be equal to the number of receive antennas. In some cases, x and may y may be a number of different values (e.g., x=1,2,4, and y=6 and 8). For, example in some switching configurations such as 1T8R, multiple SRS resources may be configured to sound the channel (e.g., 8 SRS resources total, based on the 8 channels used to receive from the base station).

In some cases, however, the may sound less than the indicated number of SRS resources to save power and network resources, or based on channel conditions that may change over time (e.g., based on one or more determinations made by the UE 115-a, or based on determinations made and indicated by the base station 105-a). Further, the UE 115-a may be in a power-saving mode, where one or more antennas are deactivated such that sounding is unnecessary at least for the deactivated antennas. In such cases, the UE 115-a may support SRS antenna switching within the operating BWP using a number of different techniques. For example, in addition to configuration signaling 215 (e.g., RRC signaling) that configures the UE with different SRSs for different BWPs (e.g., by indicating one or more SRS resource sets and which SRS resources are included in each SRS resource set), the UE 115-a may receive a MAC-CE 240 which may indicate one or more activated SRS resources for the UE 115-a to use.

For example, the configuration signaling 215 may indicate respective identifiers (e.g., indices) for each SRS resource set that is configured by the configuration signaling 215, so that the MAC-CE 240 may identify a particular SRS resource set or using an identifier (e.g., index) assigned thereto by the configuration signaling 215. Each SRS resource set may include multiple SRS resources. Further, in some cases, the configuration signaling 215 may additionally indicate respective identifiers (e.g., indices) for each SRS resource within each of the SRS resource sets configured by the configuration signaling 215, so that the MAC-CE 240 may identify a particular SRS resource within a particular SRS resource set using the identifiers (e.g., indices) assigned thereto by the configuration signaling 215.

Additionally or alternatively, the MAC-CE may indicate different SRS switching configurations directly, by configuring xTyR for example, switching from 4 SRS resources to 2 SRS resources by switching from 2T8R to 2T4R. (e.g., 2T4R includes 2 SRS resources, 2 antenna ports for each SRS resource and total 4 antennas, while 2T8R includes 4 SRS resources, 2 antenna ports for each SRS resource and 8 antennas total). In such examples, the MAC-CE may adapt xT by indicating a number of antenna ports 210 per each SRS resource ID or SRS resource set, and may adapt yR by indicating the number of SRS resource sets using one or more explicit or implicit activation/deactivation (A/D) indicators.

In some examples, the MAC-CE 240 may include an identifier (e.g., a SRS Resource Set ID) of each SRS resource set (e.g., resource sets 235-a, 235-b) whose configuration is to be adjusted. Additionally or alternatively, the MAC-CE 240 may include an indication of an activation status for each SRS resource within an identified SRS resource set (e.g., for each SRS resource, an indication of whether the SRS resource is activated or deactivated, such through a bitmap in which each bit indicates the activation status of a respective SRS resource). In some examples, the MAC-CE 240 may include the one or more A/D indicators that indicates whether the MAC-CE 240 activates additional SRS resources or deactivating additional SRS resources within SRS resource set. In some examples, for each SRS indicated as activated by the MAC-CE 240, the MAC-CE may indicate a set of one or more antenna ports the UE 115-a is to use when transmitting on the activated SRS resource (e.g., the MAC-CE 240 may include, for each activated SRS resource, a respective bitmap in which each bit indicates the activation status of a respective antenna port). In such cases, the MAC-CE may be used to support the use of different SRS switching groups.

In some examples, configuration signaling 215 may configure a set of SRS switching groups, where an SRS switching group may be a group of one or more SRS resource sets, or where an SRS switching group may be a group of one or more activated SRS resources within an SRS resource set. Where an SRS switching group is a group of one or more SRS resource sets, a subsequent MAC-CE may indicate an identifier of the group of one or more SRS resource sets whose configuration is being adapted along with an indication of how many SRS resources are activated within each SRS resource set of the SRS switching group (e.g., a single quantity applicable to all SRS resource sets of the SRS switching group, or a respective quantity for each SRS resource set of the SRS switching group). In examples where an SRS switching group is a group of activated SRS resources, a subsequent MAC-CE may indicate one or more SRS resource sets along with a corresponding SRS switching group for each of the one or more SRS resource sets. In such examples, in the identified SRS resource set, the SRS resources corresponding to the indicated SRS switching group may be activated.

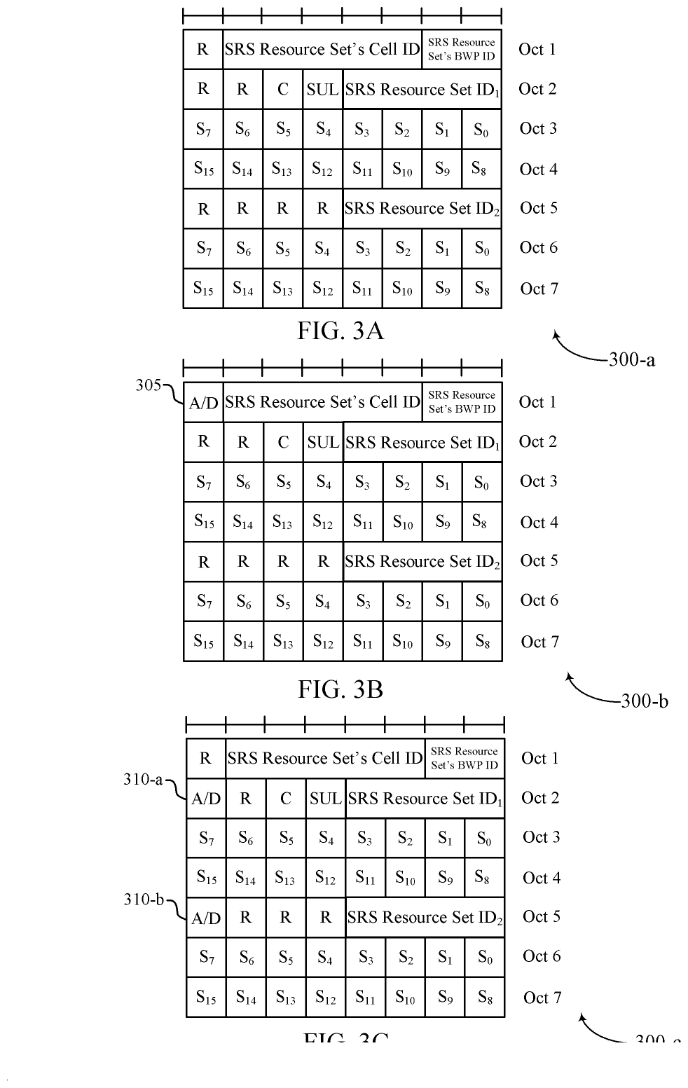

FIGS. 3A, 3B, and 3C illustrate example MAC-CE configurations 300-a, 300-b, and 300-c that support fast antenna switching for SRSs in accordance with aspects of the present disclosure. In some examples, the MAC-CE configurations 300-a, 300-b, and 300-c may be implemented or configured by aspects of wireless communications system 100, for example a UE 115 and a base station 105 as described with reference to FIGS. 1 and 2.

MAC-CE configurations 300-a, 300-b, and 300-c may support activation or deactivation of SRS resources and for dynamic SRS antenna switching within a bandwidth part. The MAC-CE configurations 300 may in some cases include a cell ID and a BWP ID associated with the SRS resource set, which may indicate the identity of the serving cell and the uplink BWP ID respectively, and which may contain the SRS resource set indicated in the MAC-CE configurations 300.

MAC-CEs 300 may include an SRS resource set ID and associated S field (e.g., following two octets). The S fields of MAC-CE configurations 300 may represent SRS resources with the indices in a corresponding SRS resource ID list (e.g., srs-ResourceIdList) configured in the SRS resource set. In some examples, the SRS resource set ID and the associated S field may indicate which SRS resource within the SRS resource set are activated or deactivated. For example, in some cases the S field include a bitmap such that an activated SRS resource may have a S field value of 1, and a deactivated SRS resource may have an S field value of 0. The C field included in MAC-CE configurations 300 may indicate whether a second SRS resource set (and corresponding SRS resources) are present.

The supplementary uplink (SUL) field of the MAC-CE configurations 300 may indicate whether the MAC-CE applies to the normal uplink (NUL) carrier configuration or to the SUL carrier configuration. For example, a UE may switch between performing uplink transmissions on the SUL carrier and the NUL carrier based on an indication in the SUL field of the MAC-CE configurations 300.

A UE may receive a MAC-CE configuration 300, and may perform fast antenna switching for SRS resources within the indicated SRS resource set. The MAC-CE configuration may further activate or deactivate SRS resources within the indicated SRS resource set.

FIG. 3A shows a MAC-CE configuration 300-a which indicates the activation or deactivation of SRS resources based on an indication in the MAC-CE configuration 300-a (e.g., rather than indication of activation or deactivation based on an explicit A/D bit). The MAC-CE configuration 300-a may instruct a UE to update (e.g., activate or deactivate) one or more SRS resources based on the indication such as an S field bitmap value. For example, if the value of an S field (e.g., Sᵢ) is set to 0, the SRS resource with index i in the corresponding SRS resource ID list (e.g., srs-ResourceIdList) configured in the indicated SRS resource set ID may be deactivated. Conversely, if the value of an S field (e.g., Sᵢ) is set to 1, the SRS resource with index i in the corresponding SRS resource ID list configured in the indicated SRS resource set ID may be activated.

In some examples, the MAC-CE configuration 300-a may support up to two SRS resource sets corresponding to SRS resource set ID1 and SRS resource set ID2. The C field of MAC-CE configuration 300-a may indicate whether a second SRS resource set (and corresponding SRS resources in Octet 6 and 7) are present in the MAC-CE configuration 300-a.

FIG. 3B shows a MAC-CE configuration 300-b which indicates the activation or deactivation of SRS resources based on a value of the A/D bit 305. The A/D bit 305 may indicate whether to activate or deactivate the SRS resource (e.g., S-field) in each SRS resource set. In such cases, the activation or deactivation by the A/D bit 305 may apply to the entire MAC-CE configuration 300-b. In such cases, the A/D bit 305 may be used to explicitly activate or deactivate the SRS resources.

For example, in some cases the A/D bit 305 may have a value of 1, activating the S field resources. In such cases, So may have a value of 1 and the SRS resource with index 0 in the SRS resource ID list (srs-ResourceIdList) configured in the indicated SRS Resource Set ID may be activated. In some cases, the A/D bit 305 may have a value of 0, deactivating the S field resources. In such cases, S₁ may have a value of 1, and the SRS resource with index 1 in the SRS resource ID list (srs-ResourceIdList) configured in the indicated SRS Resource Set ID is de-activated.

FIG. 3C shows a MAC-CE configuration 300-c which indicates the activation or deactivation of SRS resources based on a value of one or more A/D bits. For example, MAC-CE configuration 300-b may include two SRS resource sets and two corresponding A/D bits 310-a and 310-b. The value of A/D bit 310-a may be used to indicate whether to activate or deactivate the SRS resource (e.g., S-field) in the first SRS resource set corresponding to SRS Resource set ID1. The value of A/D bit 310-b may be used similarly to indicate whether to activate or deactivate the SRS resource (e.g., S-field) in the second SRS resource set corresponding to SRS Resource set ID2. In such cases, the A/D bit values may be used to explicitly activate or deactivate the SRS resources specified for each SRS resource set of the MAC-CE configuration 300-c.

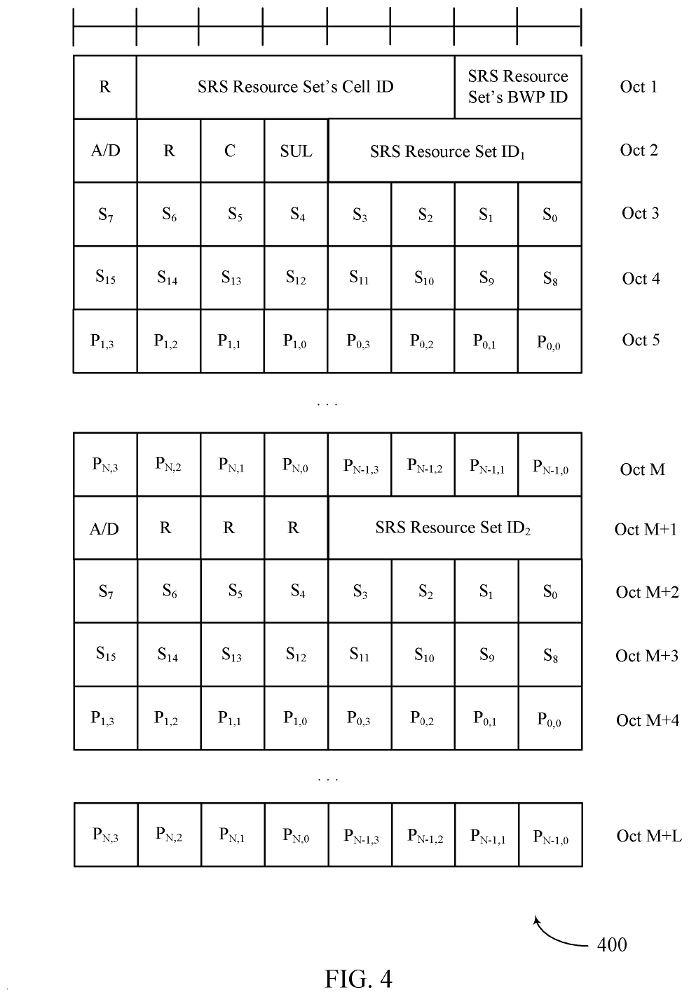

FIG. 4 illustrates an example of a MAC-CE configuration 400 that supports fast antenna switching for SRSs in accordance with aspects of the present disclosure. In some examples, the MAC-CE configuration 400 may be implemented or configured by aspects of wireless communications system 100, for example a UE 115 and a base station 105 as described with reference to FIGS. 1 and 2.

In some cases, a UE may be configured to use a number of transmit antennas as well as a number of receive antennas to transmit and receive signals. In some cases, the number of transmit antennas versus the number of receive antennas may be given by xTyR, where x may be equal to the number of transmit antennas and y may be equal to the number of receive antennas. In some cases, MAC-CE configuration 400 may be used for xT adaptation by indication of a number of antenna ports per each SRS resource ID or SRS resource set.

In some examples, the network may configure a number of antenna ports for a UE to use based on an identified UE capability. For example, a UE may support various numbers of antenna ports (e.g., 4 ports, 2 ports, 1 port) used to transmit information based on the network configuration. In some cases, a bitmap (e.g., a 4 bit bitmap) may be used such that each bit indicates a port number, and different SRS resources could have different number of ports.

MAC-CE configuration 400 may indicate which ports per SRS resource are to be activated or deactivated. For example, respective values of the 4 bits of P fields P_{0,3}, P_{0,2}, P_{0,1}, and P_{0,0,} may represent the 4 port status (e.g., activated or de-activated) for the #0 indicated SRS resource. For example, if P_{0,3}=0, P_{0,2}=0, P_{0,1}=1, P_{0,0}=1, and S₁ is the #0 indicated SRS resource of MAC-CE configuration 400, port #1 and port #0 of the SRS resource ID 1 may be activated. The presence of the P fields may be based on the value of an S field, which may be activated or inactivated based on an A/D bit. For example, activation of the P fields may be based on an S field value of 1 activated by an activated A/D bit. In cases where the A/D bit is set to zero, the S field with a bit value of 1 may be deactivated and no P fields are present (e.g., SRS resources are deactivated).

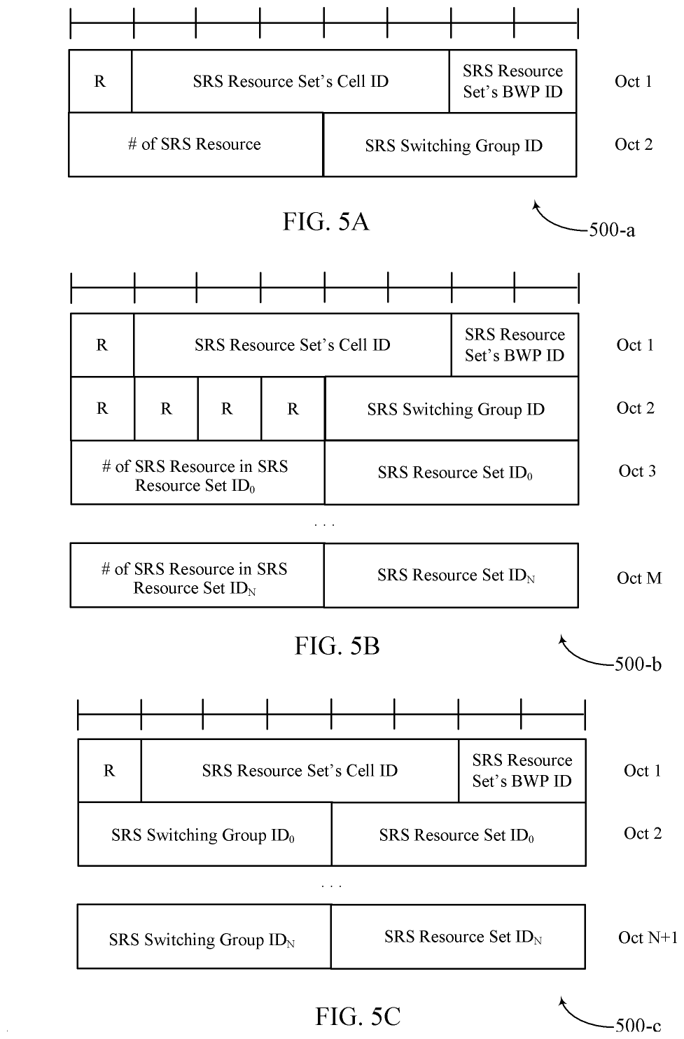

FIGS. 5A, 5B, and 5C illustrate examples of a MAC-CE configurations 500-a, 500-b, and 500-c that supports fast antenna switching for SRSs in accordance with aspects of the present disclosure. In some examples, the MAC-CE configurations 500-a, 500-b, and 500-c may be implemented or configured by aspects of wireless communications system 100, for example a UE 115 and a base station 105 as described with reference to FIGS. 1 and 2.

In some aspects, a UE may be configured with, or otherwise support, different SRS switching capabilities. For example, a UE may be configured with, or otherwise have available, a single transmit chain (1T) or with multiple transmit chains (e.g., 2T, 3T, 4T, etc.). Similarly, the UE may be configured with a single receive chain (1R) or with multiple receive chains (e.g., 2R, 3R, 4R, etc.). The UE may also be configured with one or more antennas available for the transmit and/or receive chain(s). Further, the UE may support multiple antenna configurations using the antenna(s), transmit chain(s), and/or receive chain(s). For example, UE may support directional transmissions and/or receptions using various antenna configurations and the corresponding transmit and/or receive chain(s)/antenna(s).

Different SRS switching groups may support different SRS switching capability. Each switching group may include an SRS resource set, and SRS resource sets in different group may be configured according to different SRS switching capabilities. The number of SRS resource set within the same SRS switching group may be specified or signaled to the UE by RRC signaling. In some cases, control signaling such as a MAC-CE (e.g., MAC-CE configurations 500) may be used to activate one SRS switching group, and may further indicate a number of SRS resources within the SRS resource set of the activated SRS switching group.

In addition, each switching group may include at least one SRS resource, and SRS resources in different groups may be configured based on different SRS switching capabilities. The number of SRS resources within the same SRS switching group may be specified or signaled to the UE by RRC signaling. In some cases, control signaling such as a MAC-CE may activate SRS resources by using the SRS switching group.

SRS switching may enhance channel performance estimation. For example, a UE may perform SRS transmissions according to the SRS switching configuration. A base station may measure the channel performance based on the SRS transmissions to identify or otherwise determine how the channel is performing to ensure continued communications with UE. In some aspects, base station may configure UE with one SRS switching configuration for a BWP. In such cases, however, the activation of one SRS resource set activates all the SRS resources within the SRS resource set, reducing flexibility. Thus, techniques that support SRS switching groups may allow for more dynamic activation of SRS resources within an SRS resource set.

Accordingly, aspects of the described techniques provide a more flexible mechanism for dynamic SRS switching configurations. For example, the base station may configure a MAC-CE based switching scheme for indicating the switching group and activating SRS resources.

FIG. 5A shows a MAC-CE configuration 500-a which includes an SRS switching group ID within the SRS resource, where the SRS switching group ID indicates a set of SRS resource sets indicated by the switching group ID. In some examples, the SRS switching group ID may activate the set of SRS resource sets indicated by the SRS switching group ID. In the example of MAC-CE configuration 500-a, the same number of SRS resources may be activated for each SRS resource set. Accordingly, the MAC-CE configuration 500-a may include a single field (e.g., # of SRS resource) which indicates the number of SRS resources per SRS resource set.

FIG. 5B shows a MAC-CE configuration 500-b which includes an SRS switching group ID within the SRS resource, where the SRS switching group ID indicates a set of SRS resource sets indicated by the switching group ID. In some examples, the SRS switching group ID may activate the set of SRS resource sets indicated by the SRS switching group ID. In the example of MAC-CE configuration 500-b, a different number of SRS resources may be activated for each SRS resource set. Accordingly, the MAC-CE configuration 500-b may include a corresponding SRS resource set ID which indicates the number of activated SRS resources per set. In some examples, the activated SRS resources ordered based on a resource ID list (e.g., srs-ResourceIdList) configured in each SRS resource set.

FIG. 5C shows a MAC-CE configuration 500-c which includes an SRS switching group ID within the SRS resource, where the SRS switching group ID indicates a set of SRS resource sets indicated by the switching group ID. In some examples, the SRS switching group ID may activate the set of SRS resource sets indicated by the SRS switching group ID. In the example of MAC-CE configuration 500-c, the SRS switching group ID may be used to identify a group of activated resources within each SRS resource set. For example, a SRS switching group ID (e.g., SRS switching group #0) may indicate a set of SRS resources (e.g., {SRS resource #0, SRS resource #8}) that are to be activated. In some cases, the activated resources may be indicated as a SRS antenna switching group (e.g., antennaSwitching).

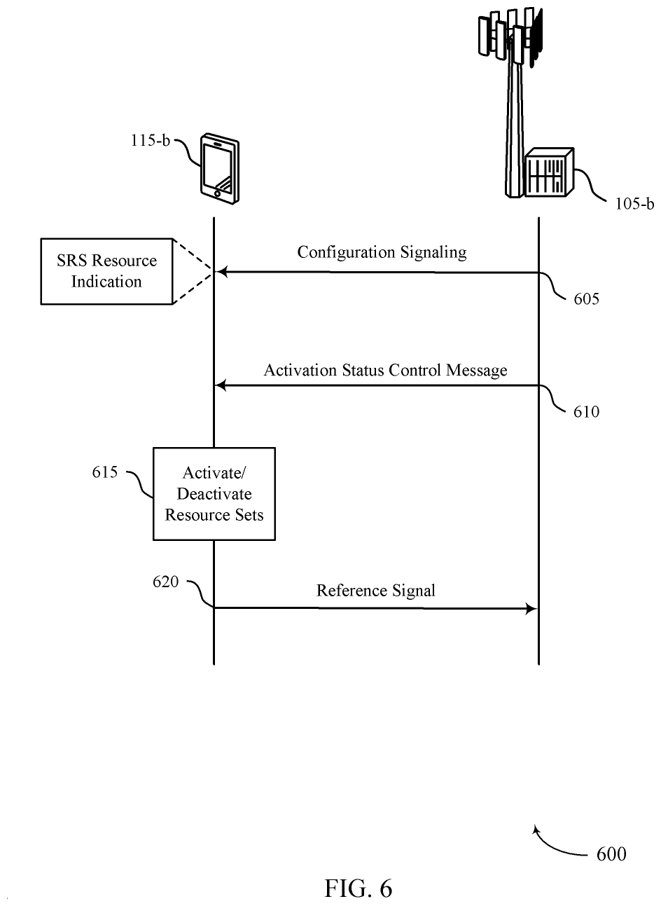

FIG. 6 illustrates an example of a process flow 600 that supports fast antenna switching for SRSs in accordance with aspects of the present disclosure. The process flow 600 may implement or be implemented by aspects of wireless communications system 100. For example, the process flow 600 may include a UE 115-b and a base station 105-a, which may be examples of a UE 115 and a base station 105, as described with reference to FIGS. 1 and 2. In the following description of the process flow 600, the operations between the UE 115-b and the base station 105-b may be transmitted in a different order than the example order shown, or the operations performed by the UE 115-b and the base station 105-b may be performed in different orders or at different times. Some operations may also be omitted from the process flow 600, and other operations may be added to the process flow 600.

At 605, the base station 105-b may transmit, and the UE 115-b may receive, configuration signaling that indicates a number of SRS resource sets, each of the number of SRS resource sets including a respective number of SRS resources. In some examples, the configuration signaling may include an indication of a respective ID for each of the SRS resource sets.

At 610, the base station 105-b may transmit, and the UE 115-b may receive, a control message (e.g., a MAC-CE) that indicates, for an SRS resource set, an activation status for an SRS resource within the SRS resource set.

In some examples, the control message may include an indication of one or more SRS resource set IDs each corresponding to a respective SRS resource set. In some examples, the control message may include an indication of a respective activation status (e.g., activated or deactivated at 615) for each SRS resource within the SRS resource set. The indication of the activation status may further include a bitmap, where each bit of the bitmap indicates the respective activation status (e.g., activated or deactivated at 615) for a corresponding SRS resource. In some examples, the control message may include an explicit indication of whether the control message is to activate or deactivate one or more SRS resources.

In some cases, the control message may include a respective indication of whether the control message is to activate or deactivate one or more SRS resources within a corresponding one of the one or more SRS resource sets at 615. The control message may in some cases indicate whether the control message is for a NUL carrier or a SUL carrier, and may include an indication of the quantity of SRS resource sets associated with the control message. The control message may further include an indication of a serving cell corresponding to the SRS resource set, an indication of a bandwidth part corresponding to the SRS resource set, or both.

In some examples, the UE 115-b may receive an indication of a respective ID for each of a number of groups of SRS resource sets, and each of the groups of SRS resource sets includes one or more SRS resource sets. The control message may indicate the SRS resource set based on including an ID of a group of SRS resource sets that includes the SRS resource set. The UE 115-b may then receive, within the control message, an indication of a quantity of activated SRS resources for each SRS resource set of the group of SRS resource sets. In such cases, the control message may indicate the activation status for the SRS resource based on including the indication of the quantity of activated SRS resources for each SRS resource set of the group of SRS resource sets. In some cases, the UE 115-b may receive, within the control message, for each SRS resource set of the group of SRS resource sets, a respective indication of a quantity of activated SRS resources within a corresponding SRS resource set. In such cases, the control message may indicates the activation status for the sounding reference signal resource based on including the respective indication of the quantity of activated SRS resources within the SRS resource set.

In some examples, the UE 115-b may receive, within the configuration signaling, an indication of a respective ID for a number of SRS resource configurations corresponding to a respective set of one or more activated SRS resources being activated. The UE 115-bmay then receive, within the control message, an indication of an ID of the SRS resource set. The control message may further include an indication of an ID of a SRS resource configuration of the SRS resource configurations. In such cases, the control message may indicate the activation status for the SRS resource at 615 based on including the indication of the ID of the SRS resource configuration.

At 620, the UE 115-b may transmit, and the baes station 105-b may receive, one or more SRSs based on the activation status for the SRS resource within the SRS resource set. For example, in some cases, the control message indicates one or more activates SRS resources associated with one or more antenna ports. In some cases, the respective indication of the respective set of one or more antenna ports may be conveyed via a bitmap, where each bit of the bitmap indicates whether a corresponding antenna port is included in the respective set of one or more antenna ports. The UE 115-b may transmit respective SRS using the respective set of one or more antenna ports for the activated SRS resource.

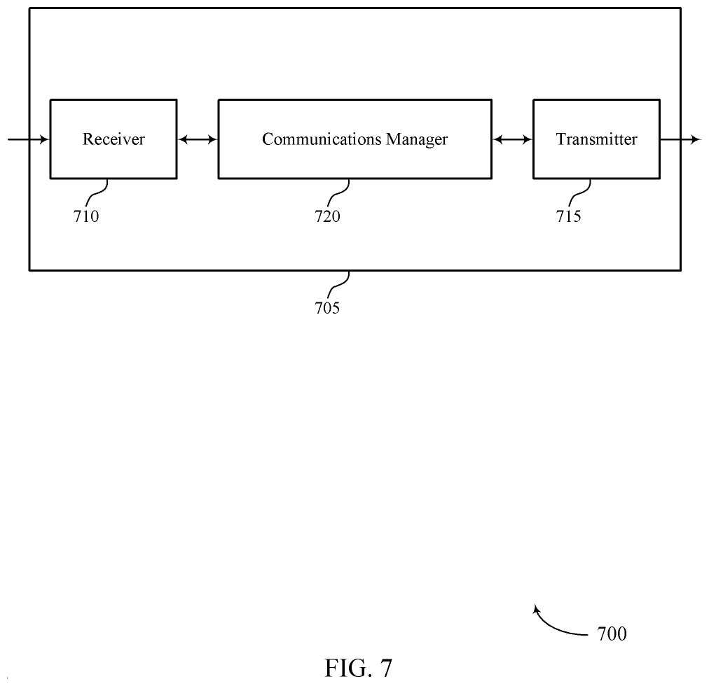

FIG. 7 shows a block diagram 700 of a device 705 that supports fast antenna switching for SRSs in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to fast antenna switching for SRSs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to fast antenna switching for SRSs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of fast antenna switching for SRSs as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may be configured to receive or transmit messages or other signaling as described herein via a transceiver. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication in accordance with examples as disclosed herein. For example, the communications manager 720 may be configured as or otherwise support a means for receiving configuration signaling that indicates a set of multiple SRS resource sets, each of the multiple SRS resource sets including a respective number of SRS resources. The communications manager 720 may be configured as or otherwise support a means for receiving a control message that indicates, for a SRS resource set of the set of multiple SRS resource sets, an activation status for a SRS resource within the SRS resource set. The communications manager 720 may be configured as or otherwise support a means for transmitting one or more SRSs based on the activation status for the SRS resource within the SRS resource set.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced power consumption (e.g., based on reduction of SRS sounding and an ability to turn off some antennas during an indicated time period), more efficient utilization of communication resources, increased efficiency and enhanced channel estimation capabilities.

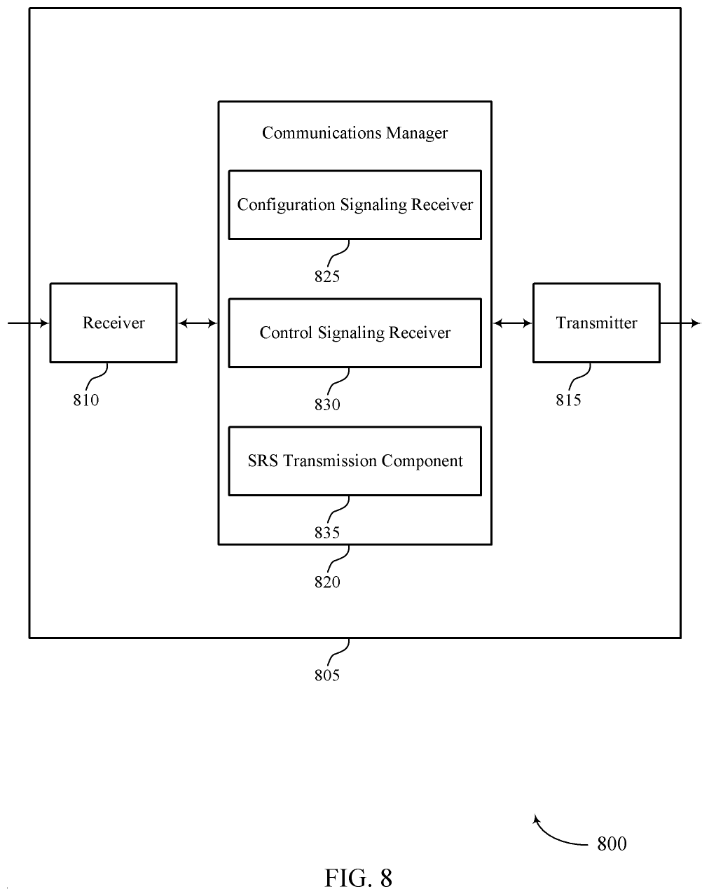

FIG. 8 shows a block diagram 800 of a device 805 that supports fast antenna switching for SRSs in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to fast antenna switching for SRSs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to fast antenna switching for SRSs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of fast antenna switching for SRSs as described herein. For example, the communications manager 820 may include a configuration signaling receiver 825, a control signaling receiver 830, an SRS transmission component 835, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication in accordance with examples as disclosed herein. The configuration signaling receiver 825 may be configured as or otherwise support a means for receiving configuration signaling that indicates a set of multiple SRS resource sets, each of the multiple SRS resource sets including a respective number of SRS resources. The control signaling receiver 830 may be configured as or otherwise support a means for receiving a control message that indicates, for a SRS resource set of the set of multiple SRS resource sets, an activation status for a SRS resource within the SRS resource set. The SRS transmission component 835 may be configured as or otherwise support a means for transmitting one or more SRSs based on the activation status for the SRS resource within the SRS resource set.

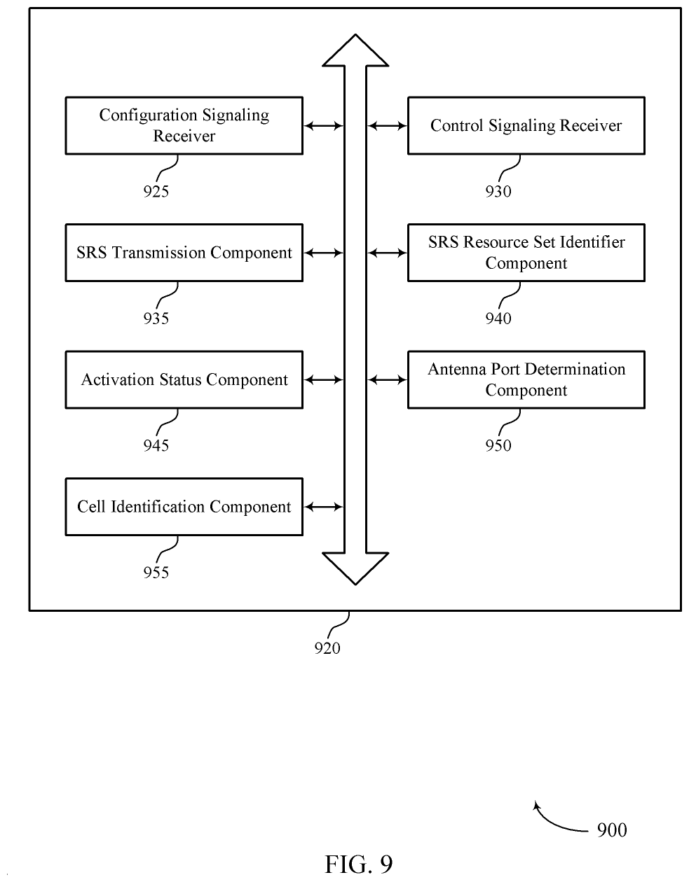

FIG. 9 shows a block diagram 900 of a communications manager 920 that supports fast antenna switching for SRSs in accordance with aspects of the present disclosure. The communications manager 920 may be an example of aspects of a communications manager 720, a communications manager 820, or both, as described herein. The communications manager 920, or various components thereof, may be an example of means for performing various aspects of fast antenna switching for SRSs as described herein. For example, the communications manager 920 may include a configuration signaling receiver 925, a control signaling receiver 930, an SRS transmission component 935, an SRS resource set identifier component 940, an activation status component 945, an antenna port determination component 950, a cell identification component 955, or any combination thereof. Each of these components may communicate, directly or indirectly, with one another (e.g., via one or more buses).

The communications manager 920 may support wireless communication in accordance with examples as disclosed herein. The configuration signaling receiver 925 may be configured as or otherwise support a means for receiving configuration signaling that indicates a set of multiple SRS resource sets, each of the multiple SRS resource sets including a respective number of SRS resources. The control signaling receiver 930 may be configured as or otherwise support a means for receiving a control message that indicates, for a SRS resource set of the set of multiple SRS resource sets, an activation status for a SRS resource within the SRS resource set. The SRS transmission component 935 may be configured as or otherwise support a means for transmitting one or more SRSs based on the activation status for the SRS resource within the SRS resource set.

In some examples, the SRS resource set identifier component 940 may be configured as or otherwise support a means for receiving, within the configuration signaling, an indication of a respective identifier for each of the set of multiple SRS resource sets. In some examples, the SRS resource set identifier component 940 may be configured as or otherwise support a means for receiving, within the control message, an indication of one or more identifiers each corresponding to a respective SRS resource set, where the one or more identifiers include an identifier of the SRS resource set.

In some examples, the activation status component 945 may be configured as or otherwise support a means for receiving, within the control message, an indication of a respective activation status for each SRS resource within the SRS resource set, the respective activation status being either activated or deactivated.

In some examples, the indication of the respective activation status for each SRS resource within the SRS resource set includes a bitmap, each bit of the bitmap indicating the respective activation status for a corresponding SRS resource.

In some examples, the activation status component 945 may be configured as or otherwise support a means for receiving, within the control message, an indication of whether the control message is to activate or deactivate one or more SRS resources.

In some examples, the activation status component 945 may be configured as or otherwise support a means for receiving, within the control message, for each of one or more SRS resource sets identified in the control message, a respective indication of whether the control message is to activate or deactivate one or more SRS resources within a corresponding one of the one or more SRS resource sets.

In some examples, the antenna port determination component 950 may be configured as or otherwise support a means for receiving, within the control message, for each of one or more activated SRS resources as indicated by the control message, a respective indication of a respective set of one or more antenna ports, where transmitting the one or more SRSs includes. In some examples, the SRS transmission component 935 may be configured as or otherwise support a means for transmitting, via each of the one or more activated SRS resources, a respective SRS using the respective set of one or more antenna ports for the activated SRS resource.

In some examples, the respective indication of the respective set of one or more antenna ports includes a bitmap, each bit of the bitmap indicating whether a corresponding antenna port is included in the respective set of one or more antenna ports.

In some examples, the control signaling receiver 930 may be configured as or otherwise support a means for receiving, within the control message, an indication of whether the control message is for a normal uplink carrier or a supplementary uplink carrier.

In some examples, the control signaling receiver 930 may be configured as or otherwise support a means for receiving, within the control message, an indication of a quantity of SRS resource sets subject to the control message.

In some examples, the SRS resource set identifier component 940 may be configured as or otherwise support a means for receiving, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set. In some examples, the control signaling receiver 930 may be configured as or otherwise support a means for receiving, within the control message, an indication of a quantity of activated SRS resources for each SRS resource set of the group of SRS resource sets, where the control message indicates the activation status for the SRS resource based on including the indication of the quantity of activated SRS resources for each SRS resource set of the group of SRS resource sets.

In some examples, the SRS resource set identifier component 940 may be configured as or otherwise support a means for receiving, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set; and. In some examples, the activation status component 945 may be configured as or otherwise support a means for receiving, within the control message, for each SRS resource set of the group of SRS resource sets, a respective indication of a quantity of activated SRS resources within a corresponding SRS resource set, where the control message indicates the activation status for the sounding reference signal resource based on including the respective indication of the quantity of activated SRS resources within the SRS resource set.

In some examples, the SRS resource set identifier component 940 may be configured as or otherwise support a means for receiving, within the configuration signaling, an indication of a respective identifier for each of a set of multiple SRS resource configurations, where the set of multiple SRS resource configurations each correspond to a respective set of one or more activated SRS resources being activated. In some examples, the SRS resource set identifier component 940 may be configured as or otherwise support a means for receiving, within the control message, an indication of an identifier of the SRS resource set. In some examples, the activation status component 945 may be configured as or otherwise support a means for receiving, within the control message, for the SRS resource set, an indication of an identifier of a SRS resource configuration of the set of multiple SRS resource configurations, where the control message indicates the activation status for the SRS resource based on including the indication of the identifier of the SRS resource configuration.

In some examples, the cell identification component 955 may be configured as or otherwise support a means for receiving, within the control message, an indication of a serving cell corresponding to the SRS resource set, an indication of a bandwidth part corresponding to the SRS resource set, or both.

In some examples, the control message includes a MAC-CE.

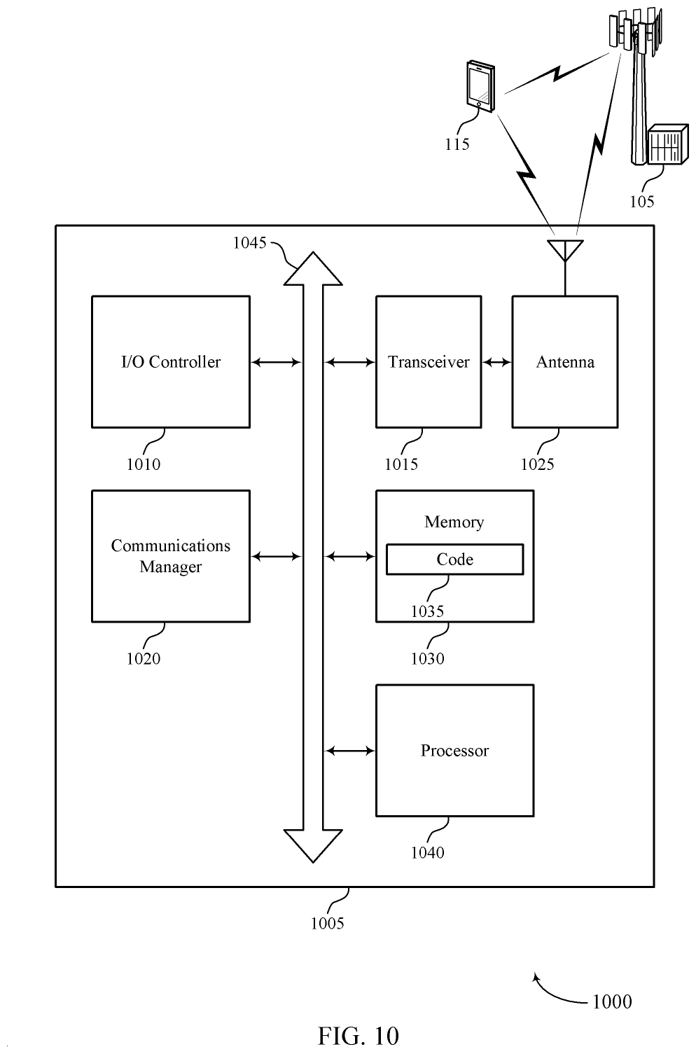

FIG. 10 shows a diagram of a system 1000 including a device 1005 that supports fast antenna switching for SRSs in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting fast antenna switching for SRSs). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication in accordance with examples as disclosed herein. For example, the communications manager 1020 may be configured as or otherwise support a means for receiving configuration signaling that indicates a set of multiple SRS resource sets, each of the multiple SRS resource sets including a respective number of SRS resources. The communications manager 1020 may be configured as or otherwise support a means for receiving a control message that indicates, for a SRS resource set of the set of multiple SRS resource sets, an activation status for a SRS resource within the SRS resource set. The communications manager 1020 may be configured as or otherwise support a means for transmitting one or more SRSs based on the activation status for the SRS resource within the SRS resource set.

By including or configuring the communications manager 1020 in accordance with examples as described herein, the device 1005 may support techniques for reduced power consumption, more efficient use of antennas at the device, more efficient utilization of communication resources, longer battery life, improved utilization of processing capability, enhanced channel estimation capabilities, and SRS resource set switching capabilities that are more dynamic through MAC-CE signaling.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of fast antenna switching for SRSs as described herein, or the processor 1040 and the memory 1030 may be otherwise configured to perform or support such operations.

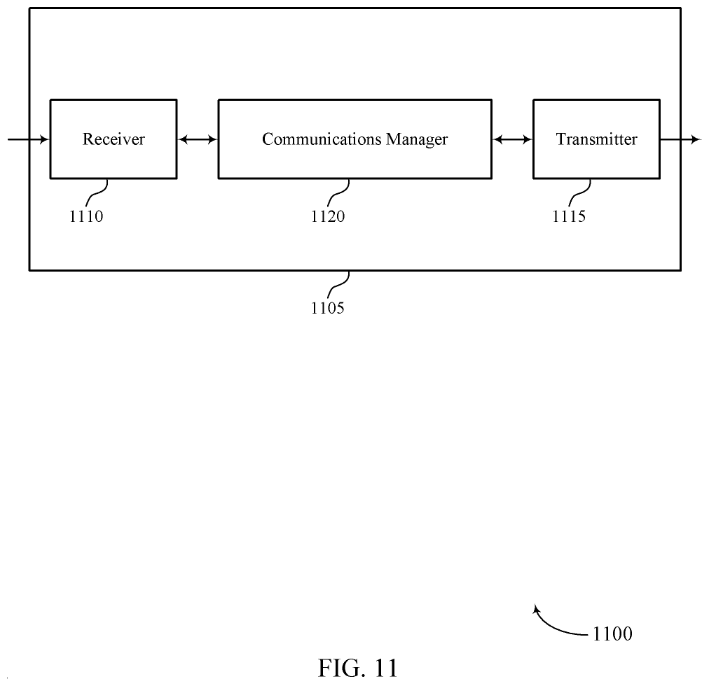

FIG. 11 shows a block diagram 1100 of a device 1105 that supports fast antenna switching for SRSs in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to fast antenna switching for SRSs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to fast antenna switching for SRSs). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of fast antenna switching for SRSs as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication in accordance with examples as disclosed herein. For example, the communications manager 1120 may be configured as or otherwise support a means for transmitting configuration signaling that indicates a set of multiple SRS resource sets, each of the multiple SRS resource sets including a respective number of SRS resources. The communications manager 1120 may be configured as or otherwise support a means for transmitting a control message that indicates, for a SRS resource set of the set of multiple SRS resource sets, an activation status for a SRS resource within the SRS resource set. The communications manager 1120 may be configured as or otherwise support a means for receiving one or more SRSs based on the activation status for the SRS resource within the SRS resource set.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced power consumption (e.g., based on reduction of SRS sounding and an ability to turn off some antennas during an indicated time period), more efficient utilization of communication resources, increased efficiency and enhanced channel estimation capabilities.

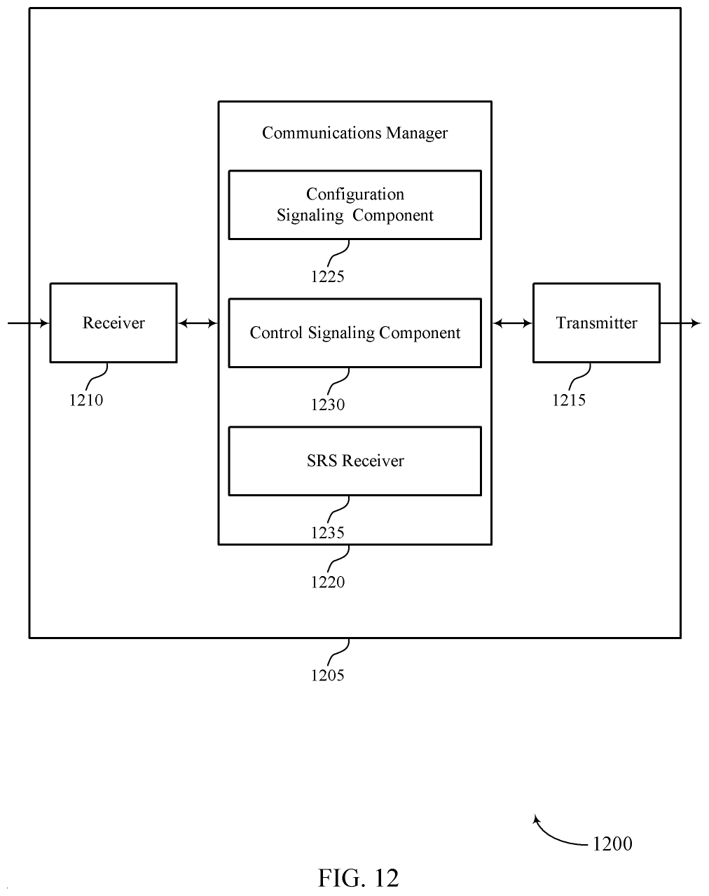

FIG. 12 shows a block diagram 1200 of a device 1205 that supports fast antenna switching for SRSs in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to fast antenna switching for SRSs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to fast antenna switching for SRSs). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of fast antenna switching for SRSs as described herein. For example, the communications manager 1220 may include a configuration signaling component 1225, a control signaling component 1230, an SRS receiver 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication in accordance with examples as disclosed herein. The configuration signaling component 1225 may be configured as or otherwise support a means for transmitting configuration signaling that indicates a set of multiple SRS resource sets, each of the multiple of SRS resource sets including a respective number of SRS resources. The control signaling component 1230 may be configured as or otherwise support a means for transmitting a control message that indicates, for a SRS resource set of the set of multiple SRS resource sets, an activation status for a SRS resource within the SRS resource set. The SRS receiver 1235 may be configured as or otherwise support a means for receiving one or more SRSs based on the activation status for the SRS resource within the SRS resource set.

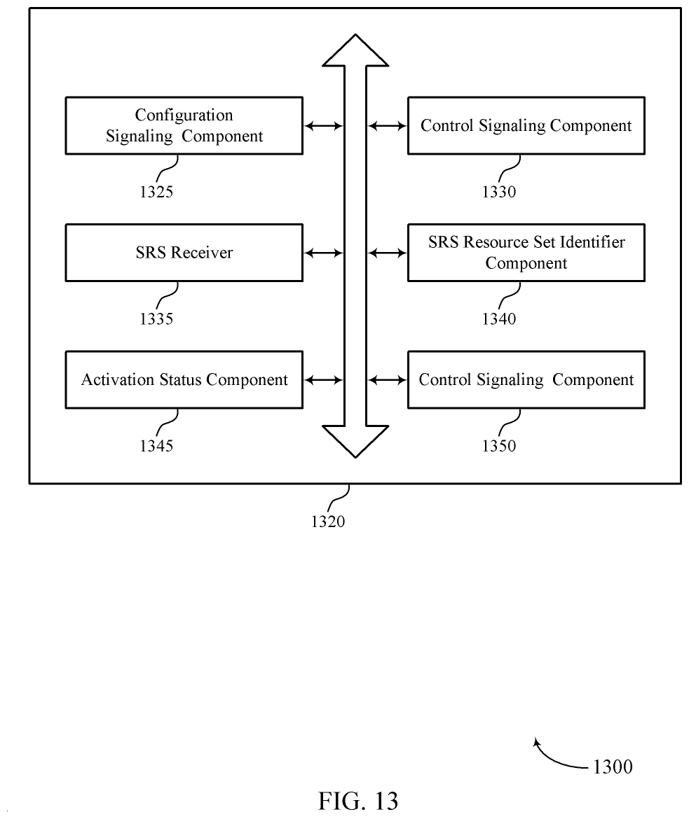

FIG. 13 shows a block diagram 1300 of a communications manager 1320 that supports fast antenna switching for SRSs in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of fast antenna switching for SRSs as described herein. For example, the communications manager 1320 may include a configuration signaling component 1325, a control signaling component 1330, an SRS receiver 1335, an SRS resource set identifier component 1340, an activation status component 1345, a control signaling component 1350, or any combination thereof. Each of these components may communicate, directly or indirectly, with one another (e.g., via one or more buses).

The communications manager 1320 may support wireless communication in accordance with examples as disclosed herein. The configuration signaling component 1325 may be configured as or otherwise support a means for transmitting configuration signaling that indicates a set of multiple SRS resource sets, each of the multiple SRS resource sets including a respective number of SRS resources. The control signaling component 1330 may be configured as or otherwise support a means for transmitting a control message that indicates, for a SRS resource set of the set of multiple SRS resource sets, an activation status for a SRS resource within the SRS resource set. The SRS receiver 1335 may be configured as or otherwise support a means for receiving one or more SRSs based on the activation status for the SRS resource within the SRS resource set.

In some examples, the SRS resource set identifier component 1340 may be configured as or otherwise support a means for transmitting, within the configuration signaling, an indication of a respective identifier for each of the set of multiple SRS resource sets. In some examples, the SRS resource set identifier component 1340 may be configured as or otherwise support a means for transmitting, within the control message, an indication of one or more identifiers each corresponding to a respective SRS resource set, where the one or more identifiers include an identifier of the SRS resource set.

In some examples, the activation status component 1345 may be configured as or otherwise support a means for transmitting, within the control message, an indication of a respective activation status for each SRS resource within the SRS resource set, the respective activation status being either activated or deactivated.

In some examples, the activation status component 1345 may be configured as or otherwise support a means for transmitting, within the control message, an indication of whether the control message is to activate or deactivate one or more SRS resources.

In some examples, the activation status component 1345 may be configured as or otherwise support a means for transmitting, within the control message, for each of one or more SRS resource sets identified in the control message, a respective indication of whether the control message is to activate or deactivate one or more SRS resources within a corresponding one of the one or more SRS resource sets.

In some examples, the activation status component 1345 may be configured as or otherwise support a means for transmitting, within the control message, for each of one or more activated SRS resources as indicated by the control message, a respective indication of a respective set of one or more antenna ports for use when transmitting a SRS via a corresponding one of the one or more SRS resources.

In some examples, the control signaling component 1330 may be configured as or otherwise support a means for transmitting, within the control message, an indication of whether the control message is for a normal uplink carrier or a supplementary uplink carrier.

In some examples, the control signaling component 1350 may be configured as or otherwise support a means for transmitting, within the control message, an indication of a quantity of SRS resource sets subject to the control message.

In some examples, the SRS resource set identifier component 1340 may be configured as or otherwise support a means for transmitting, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set. In some examples, the control signaling component 1330 may be configured as or otherwise support a means for transmitting, within the control message, an indication of a quantity of activated SRS resources for each SRS resource set of the group of SRS resource sets, where the control message indicates the activation status for the SRS resource based on including the indication of the quantity of activated SRS resources for each SRS resource set of the group of SRS resource sets.

In some examples, the SRS resource set identifier component 1340 may be configured as or otherwise support a means for transmitting, within the configuration signaling, an indication of a respective identifier for each of a set of multiple groups of SRS resource sets, each of the groups of SRS resource sets including one or more SRS resource sets, where the control message indicates the SRS resource set based on including an identifier of a group of SRS resource sets that includes the SRS resource set. In some examples, the control signaling component 1330 may be configured as or otherwise support a means for transmitting, within the control message, for each SRS resource set of the group of SRS resource sets, a respective indication of a quantity of activated SRS resources within a corresponding SRS resource set, where the control message indicates the activation status for the sounding reference signal resource based on including the respective indication of the quantity of activated SRS resources within the SRS resource set.

In some examples, the SRS resource set identifier component 1340 may be configured as or otherwise support a means for transmitting, within the configuration signaling, an indication of a respective identifier for each of a set of multiple SRS resource configurations, where the set of multiple SRS resource configurations each correspond to a respective set of one or more activated SRS resources being activated. In some examples, the control signaling component 1330 may be configured as or otherwise support a means for transmitting, within the control message, an indication of an identifier of the SRS resource set. In some examples, the SRS resource set identifier component 1340 may be configured as or otherwise support a means for transmitting, within the control message, for the SRS resource set, an indication of an identifier of a SRS resource configuration of the set of multiple SRS resource configurations, where the control message indicates the activation status for the SRS resource based on including the indication of the identifier of the SRS resource configuration. In some examples, the control message includes a MAC-CE.

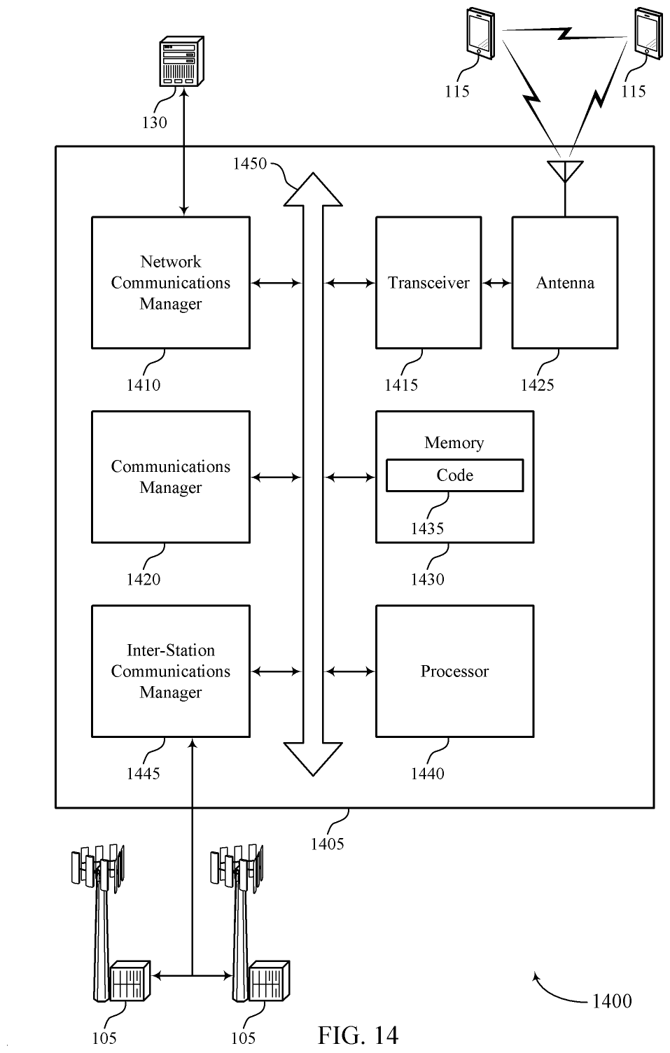

FIG. 14 shows a diagram of a system 1400 including a device 1405 that supports fast antenna switching for SRSs in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting fast antenna switching for SRSs). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication in accordance with examples as disclosed herein. For example, the communications manager 1420 may be configured as or otherwise support a means for transmitting configuration signaling that indicates a set of multiple SRS resource sets, each of the multiple SRS resource sets including a respective number of SRS resources. The communications manager 1420 may be configured as or otherwise support a means for transmitting a control message that indicates, for a SRS resource set of the set of multiple SRS resource sets, an activation status for a SRS resource within the SRS resource set. The communications manager 1420 may be configured as or otherwise support a means for receiving one or more SRSs based on the activation status for the SRS resource within the SRS resource set.

By including or configuring the communications manager 1420 in accordance with examples as described herein, the device 1405 may support techniques for reduced power consumption, more efficient use of antennas at the device, more efficient utilization of communication resources, longer battery life, improved utilization of processing capability, enhanced channel estimation capabilities, and SRS resource set switching capabilities that are more dynamic through MAC-CE signaling.

In some examples, the communications manager 1420 may be configured to perform various operations (e.g., receiving, monitoring, transmitting) using or otherwise in cooperation with the transceiver 1415, the one or more antennas 1425, or any combination thereof. For example, the communications manager 1420 may be configured to receive or transmit messages or other signaling as described herein via the transceiver 1415 Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of fast antenna switching for SRSs as described herein, or the processor 1440 and the memory 1430 may be otherwise configured to perform or support such operations.

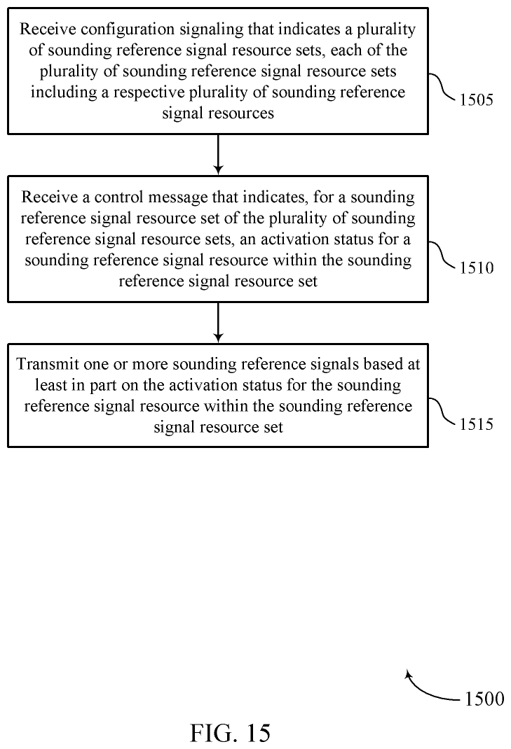

FIG. 15 shows a flowchart illustrating a method 1500 that supports fast antenna switching for SRSs in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving configuration signaling that indicates a set of multiple SRS resource sets, each of the multiple SRS resource sets including a respective number of SRS resources. The operations of 1505 may be performed in accordance with examples as disclosed herein. In some examples, aspects of the operations of 1505 may be performed by a configuration signaling receiver 925 as described with reference to FIG. 9. Additionally or alternatively, means for performing 1505 may, but not necessarily, include, for example, antenna 1025, transceiver 1015, communications manager 1020, memory 1030 (including code 1035), processor 1040 and/or bus 1045.

At 1510, the method may include receiving a control message that indicates, for a SRS resource set of the set of multiple SRS resource sets, an activation status for a SRS resource within the SRS resource set. The operations of 1510 may be performed in accordance with examples as disclosed herein. In some examples, aspects of the operations of 1510 may be performed by a control signaling receiver 930 as described with reference to FIG. 9. Additionally or alternatively, means for performing 1510 may, but not necessarily, include, for example, antenna 1025, transceiver 1015, communications manager 1020, memory 1030 (including code 1035), processor 1040 and/or bus 1045.

At 1515, the method may include transmitting one or more SRSs based on the activation status for the SRS resource within the SRS resource set. The operations of 1515 may be performed in accordance with examples as disclosed herein. In some examples, aspects of the operations of 1515 may be performed by an SRS transmission component 935 as described with reference to FIG. 9. Additionally or alternatively, means for performing 1515 may, but not necessarily, include, for example, antenna 1025, transceiver 1015, communications manager 1020, memory 1030 (including code 1035), processor 1040 and/or bus 1045.

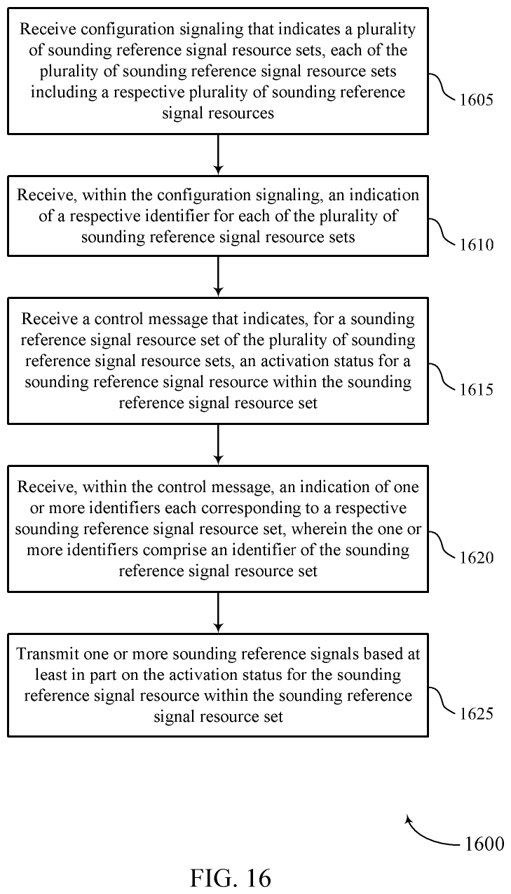

FIG. 16 shows a flowchart illustrating a method 1600 that supports fast antenna switching for SRSs in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving configuration signaling that indicates a set of multiple SRS resource sets, each of the multiple SRS resource sets including a respective number of SRS resources. The operations of 1605 may be performed in accordance with examples as disclosed herein. In some examples, aspects of the operations of 1605 may be performed by a configuration signaling receiver 925 as described with reference to FIG. 9.

At 1610, the method may include receiving, within the configuration signaling, an indication of a respective identifier for each of the set of multiple SRS resource sets. The operations of 1610 may be performed in accordance with examples as disclosed herein. In some examples, aspects of the operations of 1610 may be performed by an SRS resource set identifier component 940 as described with reference to FIG. 9.

At 1615, the method may include receiving a control message that indicates, for a SRS resource set of the set of multiple SRS resource sets, an activation status for a SRS resource within the SRS resource set. The operations of 1615 may be performed in accordance with examples as disclosed herein. In some examples, aspects of the operations of 1615 may be performed by a control signaling receiver 930 as described with reference to FIG. 9.

At 1620, the method may include receiving, within the control message, an indication of one or more identifiers each corresponding to a respective SRS resource set, where the one or more identifiers include an identifier of the SRS resource set. The operations of 1620 may be performed in accordance with examples as disclosed herein. In some examples, aspects of the operations of 1620 may be performed by an SRS resource set identifier component 940 as described with reference to FIG. 9.

At 1625, the method may include transmitting one or more SRSs based on the activation status for the SRS resource within the SRS resource set. The operations of 1625 may be performed in accordance with examples as disclosed herein. In some examples, aspects of the operations of 1625 may be performed by an SRS transmission component 935 as described with reference to FIG. 9.

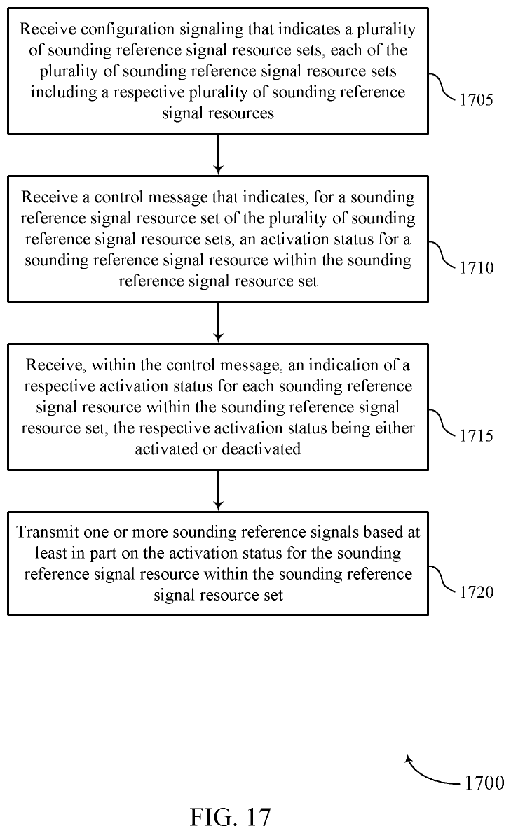

FIG. 17 shows a flowchart illustrating a method 1700 that supports fast antenna switching for SRSs in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include receiving configuration signaling that indicates a set of multiple SRS resource sets, each of the multiple SRS resource sets including a respective number of SRS resources. The operations of 1705 may be performed in accordance with examples as disclosed herein. In some examples, aspects of the operations of 1705 may be performed by a configuration signaling receiver 925 as described with reference to FIG. 9.

At 1710, the method may include receiving a control message that indicates, for a SRS resource set of the set of multiple SRS resource sets, an activation status for a SRS resource within the SRS resource set. The operations of 1710 may be performed in accordance with examples as disclosed herein. In some examples, aspects of the operations of 1710 may be performed by a control signaling receiver 930 as described with reference to FIG. 9.

At 1715, the method may include receiving, within the control message, an indication of a respective activation status for each SRS resource within the SRS resource set, the respective activation status being either activated or deactivated. The operations of 1715 may be performed in accordance with examples as disclosed herein. In some examples, aspects of the operations of 1715 may be performed by an activation status component 945 as described with reference to FIG. 9.

At 1720, the method may include transmitting one or more SRSs based on the activation status for the SRS resource within the SRS resource set. The operations of 1720 may be performed in accordance with examples as disclosed herein. In some examples, aspects of the operations of 1720 may be performed by an SRS transmission component 935 as described with reference to FIG. 9.

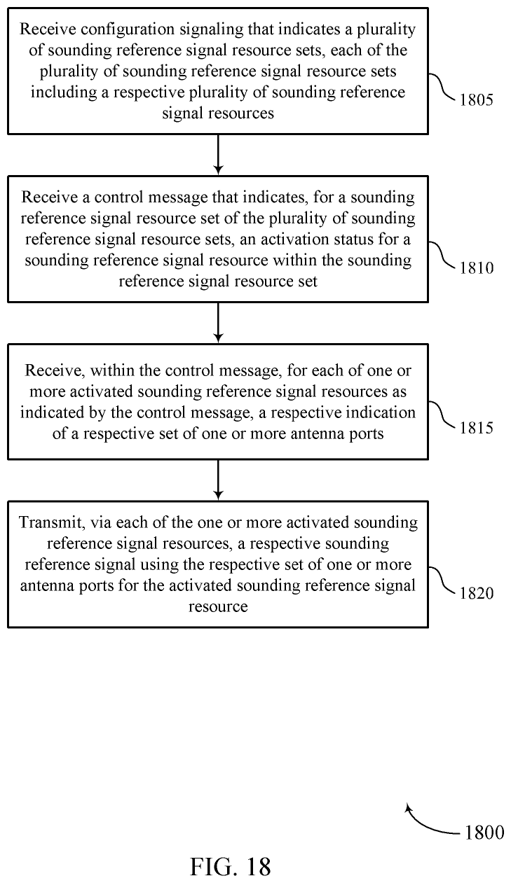

FIG. 18 shows a flowchart illustrating a method 1800 that supports fast antenna switching for SRSs in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1805, the method may include receiving configuration signaling that indicates a set of multiple SRS resource sets, each of the multiple SRS resource sets including a respective number of SRS resources. The operations of 1805 may be performed in accordance with examples as disclosed herein. In some examples, aspects of the operations of 1805 may be performed by a configuration signaling receiver 925 as described with reference to FIG. 9.

At 1810, the method may include receiving a control message that indicates, for a SRS resource set of the set of multiple SRS resource sets, an activation status for a SRS resource within the SRS resource set. The operations of 1810 may be performed in accordance with examples as disclosed herein. In some examples, aspects of the operations of 1810 may be performed by a control signaling receiver 930 as described with reference to FIG. 9.

At 1815, the method may include receiving, within the control message, for each of one or more activated SRS resources as indicated by the control message, a respective indication of a respective set of one or more antenna ports. The operations of 1815 may be performed in accordance with examples as disclosed herein. In some examples, aspects of the operations of 1815 may be performed by an antenna port determination component 950 as described with reference to FIG. 9.

At 1820, the method may include transmitting, via each of the one or more activated SRS resources, a respective SRS using the respective set of one or more antenna ports for the activated SRS resource. The operations of 1820 may be performed in accordance with examples as disclosed herein. In some examples, aspects of the operations of 1820 may be performed by an SRS transmission component 935 as described with reference to FIG. 9.

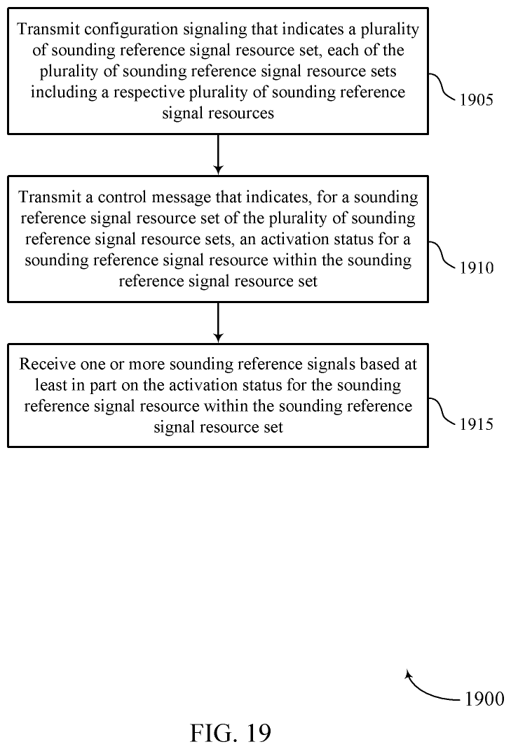

FIG. 19 shows a flowchart illustrating a method 1900 that supports fast antenna switching for SRSs in accordance with aspects of the present disclosure. The operations of the method 1900 may be implemented by a base station or its components as described herein. For example, the operations of the method 1900 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1905, the method may include transmitting configuration signaling that indicates a set of multiple SRS resource sets, each of the multiple SRS resource sets including a respective number of SRS resources. The operations of 1905 may be performed in accordance with examples as disclosed herein. In some examples, aspects of the operations of 1905 may be performed by a configuration signaling component 1325 as described with reference to FIG. 13. Additionally or alternatively, means for performing 1905 may, but not necessarily, include, for example, antenna 1025, transceiver 1015, communications manager 1020, memory 1030 (including code 1035), processor 1040 and/or bus 1045.

At 1910, the method may include transmitting a control message that indicates, for a SRS resource set of the set of multiple SRS resource sets, an activation status for a SRS resource within the SRS resource set. The operations of 1910 may be performed in accordance with examples as disclosed herein. In some examples, aspects of the operations of 1910 may be performed by a control signaling component 1330 as described with reference to FIG. 13. Additionally or alternatively, means for performing 1910 may, but not necessarily, include, for example, antenna 1025, transceiver 1015, communications manager 1020, memory 1030 (including code 1035), processor 1040 and/or bus 1045.

At 1915, the method may include receiving one or more SRSs based on the activation status for the SRS resource within the SRS resource set. The operations of 1915 may be performed in accordance with examples as disclosed herein. In some examples, aspects of the operations of 1915 may be performed by an SRS receiver 1335 as described with reference to FIG. 13. Additionally or alternatively, means for performing 1915 may, but not necessarily, include, for example, antenna 1025, transceiver 1015, communications manager 1020, memory 1030 (including code 1035), processor 1040 and/or bus 1045.

The following provides an overview of aspects of the present disclosure:

Aspect 1: A method for wireless communication, comprising: receiving configuration signaling that indicates a plurality of SRS resource sets, each of the plurality of SRS resource sets comprising a respective plurality of SRS resources; receiving a control message that indicates, for a SRS resource set of the plurality of SRS resource sets, an activation status for a SRS resource within the SRS resource set; and transmitting one or more SRSs based at least in part on the activation status for the SRS resource within the SRS resource set.

Aspect 2: The method of aspect 1, further comprising: receiving, within the configuration signaling, an indication of a respective identifier for each of the plurality of SRS resource sets; and receiving, within the control message, an indication of one or more identifiers each corresponding to a respective SRS resource set, wherein the one or more identifiers comprise an identifier of the SRS resource set.

Aspect 3: The method of any of aspects 1 through 2, further comprising: receiving, within the control message, an indication of a respective activation status for each SRS resource within the SRS resource set, the respective activation status being either activated or deactivated.

Aspect 4: The method of aspect 3, wherein the indication of the respective activation status for each SRS resource within the SRS resource set comprises a bitmap, each bit of the bitmap indicating the respective activation status for a corresponding SRS resource.

Aspect 5: The method of any of aspects 1 through 4, further comprising: receiving, within the control message, an indication of whether the control message is to activate or deactivate one or more SRS resources.

Aspect 6: The method of any of aspects 1 through 5, further comprising: receiving, within the control message, for each of one or more SRS resource sets identified in the control message, a respective indication of whether the control message is to activate or deactivate one or more SRS resources within a corresponding one of the one or more SRS resource sets.

Aspect 7: The method of any of aspects 1 through 6, further comprising: receiving, within the control message, for each of one or more activated SRS resources as indicated by the control message, a respective indication of a respective set of one or more antenna ports, wherein transmitting the one or more SRSs comprises: transmitting, via each of the one or more activated SRS resources, a respective SRS using the respective set of one or more antenna ports for the activated SRS resource.

Aspect 8: The method of aspect 7, wherein the respective indication of the respective set of one or more antenna ports comprises a bitmap, each bit of the bitmap indicating whether a corresponding antenna port is included in the respective set of one or more antenna ports.

Aspect 9: The method of any of aspects 1 through 8, further comprising: receiving, within the control message, an indication of whether the control message is for a normal uplink carrier or a supplementary uplink carrier.

Aspect 10: The method of any of aspects 1 through 9, further comprising: receiving, within the control message, an indication of a quantity of SRS resource sets subject to the control message.

Aspect 11: The method of any of aspects 1 through 10, further comprising: receiving, within the configuration signaling, an indication of a respective identifier for each of a plurality of groups of SRS resource sets, each of the groups of SRS resource sets comprising one or more SRS resource sets, wherein the control message indicates the SRS resource set based at least in part on including an identifier of a group of SRS resource sets that includes the SRS resource set; and receiving, within the control message, an indication of a quantity of activated SRS resources for each SRS resource set of the group of SRS resource sets, wherein the control message indicates the activation status for the SRS resource based at least in part on including the indication of the quantity of activated SRS resources for each SRS resource set of the group of SRS resource sets.

Aspect 12: The method of any of aspects 1 through 11, further comprising: receiving, within the configuration signaling, an indication of a respective identifier for each of a plurality of groups of SRS resource sets, each of the groups of SRS resource sets comprising one or more SRS resource sets, wherein the control message indicates the SRS resource set based at least in part on including an identifier of a group of SRS resource sets that includes the SRS resource set; and receiving, within the control message, for each SRS resource set of the group of SRS resource sets, a respective indication of a quantity of activated SRS resources within a corresponding SRS resource set, wherein the control message indicates the activation status for the sounding reference signal resource based at least in part on including the respective indication of the quantity of activated SRS resources within the SRS resource set.

Aspect 13: The method of any of aspects 1 through 12, further comprising: receiving, within the configuration signaling, an indication of a respective identifier for each of a plurality of SRS resource configurations, wherein the plurality of SRS resource configurations each correspond to a respective set of one or more activated SRS resources being activated; receiving, within the control message, an indication of an identifier of the SRS resource set; and receiving, within the control message, for the SRS resource set, an indication of an identifier of a SRS resource configuration of the plurality of SRS resource configurations, wherein the control message indicates the activation status for the SRS resource based at least in part on including the indication of the identifier of the SRS resource configuration.

Aspect 14: The method of any of aspects 1 through 13, further comprising: receiving, within the control message, an indication of a serving cell corresponding to the SRS resource set, an indication of a BWP corresponding to the SRS resource set, or both.

Aspect 15: The method of any of aspects 1 through 14, wherein the control message comprises a MAC-CE.

Aspect 16: A method for wireless communication, comprising: transmitting configuration signaling that indicates a plurality of SRS resource sets, each of the plurality of SRS resource sets comprising a respective plurality of SRS resources; transmitting a control message that indicates, for a SRS resource set of the plurality of SRS resource sets, an activation status for a SRS resource within the SRS resource set; and receiving one or more SRSs based at least in part on the activation status for the SRS resource within the SRS resource set.

Aspect 17: The method of aspect 16, further comprising: transmitting, within the configuration signaling, an indication of a respective identifier for each of the plurality of SRS resource sets; and transmitting, within the control message, an indication of one or more identifiers each corresponding to a respective SRS resource set, wherein the one or more identifiers comprise an identifier of the SRS resource set.

Aspect 18: The method of any of aspects 16 through 17, further comprising: transmitting, within the control message, an indication of a respective activation status for each SRS resource within the SRS resource set, the respective activation status being either activated or deactivated.

Aspect 19: The method of any of aspects 16 through 18, further comprising: transmitting, within the control message, an indication of whether the control message is to activate or deactivate one or more SRS resources.

Aspect 20: The method of any of aspects 16 through 19, further comprising: transmitting, within the control message, for each of one or more SRS resource sets identified in the control message, a respective indication of whether the control message is to activate or deactivate one or more SRS resources within a corresponding one of the one or more SRS resource sets.

Aspect 21: The method of any of aspects 16 through 20, further comprising: transmitting, within the control message, for each of one or more activated SRS resources as indicated by the control message, a respective indication of a respective set of one or more antenna ports for use when transmitting a SRS via a corresponding one of the one or more SRS resources.

Aspect 22: The method of any of aspects 16 through 21, further comprising: transmitting, within the control message, an indication of whether the control message is for a normal uplink carrier or a supplementary uplink carrier.

Aspect 23: The method of any of aspects 16 through 22, further comprising: transmitting, within the control message, an indication of a quantity of SRS resource sets subject to the control message.

Aspect 24: The method of any of aspects 16 through 23, further comprising: transmitting, within the configuration signaling, an indication of a respective identifier for each of a plurality of groups of SRS resource sets, each of the groups of SRS resource sets comprising one or more SRS resource sets, wherein the control message indicates the SRS resource set based at least in part on including an identifier of a group of SRS resource sets that includes the SRS resource set; and transmitting, within the control message, an indication of a quantity of activated SRS resources for each SRS resource set of the group of SRS resource sets, wherein the control message indicates the activation status for the SRS resource based at least in part on including the indication of the quantity of activated SRS resources for each SRS resource set of the group of SRS resource sets.

Aspect 25: The method of any of aspects 16 through 24, further comprising: transmitting, within the configuration signaling, an indication of a respective identifier for each of a plurality of groups of SRS resource sets, each of the groups of SRS resource sets comprising one or more SRS resource sets, wherein the control message indicates the SRS resource set based at least in part on including an identifier of a group of SRS resource sets that includes the SRS resource set; and transmitting, within the control message, for each SRS resource set of the group of SRS resource sets, a respective indication of a quantity of activated SRS resources within a corresponding SRS resource set, wherein the control message indicates the activation status for the sounding reference signal resource based at least in part on including the respective indication of the quantity of activated SRS resources within the SRS resource set.

Aspect 26: The method of any of aspects 16 through 25, further comprising: transmitting, within the configuration signaling, an indication of a respective identifier for each of a plurality of SRS resource configurations, wherein the plurality of SRS resource configurations each correspond to a respective set of one or more activated SRS resources being activated; transmitting, within the control message, an indication of an identifier of the SRS resource set; and transmitting, within the control message, for the SRS resource set, an indication of an identifier of a SRS resource configuration of the plurality of SRS resource configurations, wherein the control message indicates the activation status for the SRS resource based at least in part on including the indication of the identifier of the SRS resource configuration.

Aspect 27: The method of any of aspects 16 through 26, wherein the control message comprises a MAC-CE.

Aspect 28: An apparatus for wireless communication, comprising a processor; memory coupled with the processor; and instructions stored in the memory and executable by the processor to cause the apparatus to perform a method of any of aspects 1 through 15.

Aspect 29: An apparatus for wireless communication, comprising at least one means for performing a method of any of aspects 1 through 15.

Aspect 30: A non-transitory computer-readable medium storing code for wireless communication, the code comprising instructions executable by a processor to perform a method of any of aspects 1 through 15.

Aspect 31: An apparatus for wireless communication, comprising a processor; memory coupled with the processor; and instructions stored in the memory and executable by the processor to cause the apparatus to perform a method of any of aspects 16 through 27.

Aspect 32: An apparatus for wireless communication, comprising at least one means for performing a method of any of aspects 16 through 27.

Aspect 33: A non-transitory computer-readable medium storing code for wireless communication, the code comprising instructions executable by a processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication, comprising:
receiving configuration signaling that indicates a plurality of sounding reference signal resource sets, each of the plurality of sounding reference signal resource sets comprising a respective plurality of sounding reference signal resources;
receiving a control message that indicates, for a sounding reference signal resource set of the plurality of sounding reference signal resource sets, an activation status for a sounding reference signal resource within the sounding reference signal resource set; and
transmitting one or more sounding reference signals based at least in part on the activation status for the sounding reference signal resource within the sounding reference signal resource set.

2. The method of claim 1, further comprising:
receiving, within the configuration signaling, an indication of a respective identifier for each of the plurality of sounding reference signal resource sets; and
receiving, within the control message, an indication of one or more identifiers each corresponding to a respective sounding reference signal resource set, wherein the one or more identifiers comprise an identifier of the sounding reference signal resource set.

3. The method of claim 1, further comprising:
receiving, within the control message, an indication of a respective activation status for each sounding reference signal resource within the sounding reference signal resource set, the respective activation status being either activated or deactivated.

4. The method of claim 3, wherein the indication of the respective activation status for each sounding reference signal resource within the sounding reference signal resource set comprises a bitmap, each bit of the bitmap indicating the respective activation status for a corresponding sounding reference signal resource.

5. The method of claim 1, further comprising:
receiving, within the control message, an indication of whether the control message is to activate or deactivate one or more sounding reference signal resources.

6. The method of claim 1, further comprising:
receiving, within the control message, for each of one or more sounding reference signal resource sets identified in the control message, a respective indication of whether the control message is to activate or deactivate one or more sounding reference signal resources within a corresponding one of the one or more sounding reference signal resource sets.

7. The method of claim 1, further comprising:
receiving, within the control message, for each of one or more activated sounding reference signal resources as indicated by the control message, a respective indication of a respective set of one or more antenna ports, wherein transmitting the one or more sounding reference signals comprises:
transmitting, via each of the one or more activated sounding reference signal resources, a respective sounding reference signal using the respective set of one or more antenna ports for the activated sounding reference signal resource.

8. The method of claim 7, wherein the respective indication of the respective set of one or more antenna ports comprises a bitmap, each bit of the bitmap indicating whether a corresponding antenna port is included in the respective set of one or more antenna ports.

9. The method of claim 1, further comprising:
receiving, within the control message, an indication of whether the control message is for a normal uplink carrier or a supplementary uplink carrier.

10. The method of claim 1, further comprising:
receiving, within the control message, an indication of a quantity of sounding reference signal resource sets subject to the control message.

11. The method of claim 1, further comprising:
receiving, within the configuration signaling, an indication of a respective identifier for each of a plurality of groups of sounding reference signal resource sets, each of the groups of sounding reference signal resource sets comprising one or more sounding reference signal resource sets, wherein the control message indicates the sounding reference signal resource set based at least in part on including an identifier of a group of sounding reference signal resource sets that includes the sounding reference signal resource set; and
receiving, within the control message, an indication of a quantity of activated sounding reference signal resources for each sounding reference signal resource set of the group of sounding reference signal resource sets, wherein the control message indicates the activation status for the sounding reference signal resource based at least in part on including the indication of the quantity of activated sounding reference signal resources for each sounding reference signal resource set of the group of sounding reference signal resource sets.

12. The method of claim 1, further comprising:
receiving, within the configuration signaling, an indication of a respective identifier for each of a plurality of groups of sounding reference signal resource sets, each of the groups of sounding reference signal resource sets comprising one or more sounding reference signal resource sets, wherein the control message indicates the sounding reference signal resource set based at least in part on including an identifier of a group of sounding reference signal resource sets that includes the sounding reference signal resource set; and
receiving, within the control message, for each sounding reference signal resource set of the group of sounding reference signal resource sets, a respective indication of a quantity of activated sounding reference signal resources within a corresponding sounding reference signal resource set, wherein the control message indicates the activation status for the sounding reference signal resource based at least in part on including the respective indication of the quantity of activated sounding reference signal resources within the sounding reference signal resource set.

13. The method of claim 1, further comprising:
receiving, within the configuration signaling, an indication of a respective identifier for each of a plurality of sounding reference signal resource configurations, wherein the plurality of sounding reference signal resource configurations each correspond to a respective set of one or more activated sounding reference signal resources being activated;
receiving, within the control message, an indication of an identifier of the sounding reference signal resource set; and
receiving, within the control message, for the sounding reference signal resource set, an indication of an identifier of a sounding reference signal resource configuration of the plurality of sounding reference signal resource configurations, wherein the control message indicates the activation status for the sounding reference signal resource based at least in part on including the indication of the identifier of the sounding reference signal resource configuration.

14. The method of claim 1, further comprising:
receiving, within the control message, an indication of a serving cell corresponding to the sounding reference signal resource set, an indication of a bandwidth part corresponding to the sounding reference signal resource set, or both.

15. The method of claim 1, wherein the control message comprises a medium access control-control element.

16. A method for wireless communication, comprising:
transmitting configuration signaling that indicates a plurality of sounding reference signal resource sets, each of the plurality of sounding reference signal resource sets comprising a respective plurality of sounding reference signal resources;
transmitting a control message that indicates, for a sounding reference signal resource set of the plurality of sounding reference signal resource sets, an activation status for a sounding reference signal resource within the sounding reference signal resource set; and
receiving one or more sounding reference signals based at least in part on the activation status for the sounding reference signal resource within the sounding reference signal resource set.

17. The method of claim 16, further comprising:
transmitting, within the configuration signaling, an indication of a respective identifier for each of the plurality of sounding reference signal resource sets; and
transmitting, within the control message, an indication of one or more identifiers each corresponding to a respective sounding reference signal resource set, wherein the one or more identifiers comprise an identifier of the sounding reference signal resource set.

18. The method of claim 16, further comprising:
transmitting, within the control message, an indication of a respective activation status for each sounding reference signal resource within the sounding reference signal resource set, the respective activation status being either activated or deactivated.

19. The method of claim 16, further comprising:
transmitting, within the control message, an indication of whether the control message is to activate or deactivate one or more sounding reference signal resources.

20. The method of claim 16, further comprising:
transmitting, within the control message, for each of one or more sounding reference signal resource sets identified in the control message, a respective indication of whether the control message is to activate or deactivate one or more sounding reference signal resources within a corresponding one of the one or more sounding reference signal resource sets.

21. The method of claim 16, further comprising:
transmitting, within the control message, for each of one or more activated sounding reference signal resources as indicated by the control message, a respective indication of a respective set of one or more antenna ports for use when transmitting a sounding reference signal via a corresponding one of the one or more sounding reference signal resources.

22. The method of claim 16, further comprising:
transmitting, within the control message, an indication of whether the control message is for a normal uplink carrier or a supplementary uplink carrier, an indication of a quantity of sounding reference signal resource sets subject to the control message, or both.

23. The method of claim 16, further comprising:
transmitting, within the configuration signaling, an indication of a respective identifier for each of a plurality of groups of sounding reference signal resource sets, each of the groups of sounding reference signal resource sets comprising one or more sounding reference signal resource sets, wherein the control message indicates the sounding reference signal resource set based at least in part on including an identifier of a group of sounding reference signal resource sets that includes the sounding reference signal resource set; and
transmitting, within the control message:
an indication of a quantity of activated sounding reference signal resources for each sounding reference signal resource set of the group of sounding reference signal resource sets, wherein the control message indicates the activation status for the sounding reference signal resource based at least in part on including the indication of the quantity of activated sounding reference signal resources for each sounding reference signal resource set of the group of sounding reference signal resource sets; or
for each sounding reference signal resource set of the group of sounding reference signal resource sets, a respective indication of a quantity of activated sounding reference signal resources within a corresponding sounding reference signal resource set, wherein the control message indicates the activation status for the sounding reference signal resource based at least in part on including the respective indication of the quantity of activated sounding reference signal resources within the sounding reference signal resource set.

24. The method of claim 16, further comprising:
transmitting, within the configuration signaling, an indication of a respective identifier for each of a plurality of sounding reference signal resource configurations, wherein the plurality of sounding reference signal resource configurations each correspond to a respective set of one or more activated sounding reference signal resources being activated;
transmitting, within the control message, an indication of an identifier of the sounding reference signal resource set; and
transmitting, within the control message, for the sounding reference signal resource set, an indication of an identifier of a sounding reference signal resource configuration of the plurality of sounding reference signal resource configurations, wherein the control message indicates the activation status for the sounding reference signal resource based at least in part on including the indication of the identifier of the sounding reference signal resource configuration.

25. An apparatus for wireless communications, comprising:
a processor of a user equipment (UE);
a transceiver coupled with the processor; and
memory coupled with the processor, the memory and the processor configured to cause the apparatus to:
receive, via the transceiver, configuration signaling that indicates a plurality of sounding reference signal resource sets and a respective set of sounding reference signal resources within each of the plurality of sounding reference signal resource sets;
receive, via the transceiver, a control message that indicates, for a sounding reference signal resource set of the plurality of sounding reference signal resource sets, an activation status for a sounding reference signal resource within the sounding reference signal resource set; and
transmit, via the transceiver, one or more sounding reference signals based at least in part on the activation status for the sounding reference signal resource within the sounding reference signal resource set.

26. The apparatus of claim 25, the memory and the processor further configured to cause the apparatus to:
receive, via the transceiver and within the configuration signaling, an indication of a respective identifier for each of the plurality of sounding reference signal resource sets; and
receive, via the transceiver and within the control message, an indication of one or more identifiers each corresponding to a respective sounding reference signal resource set, wherein the one or more identifiers comprise an identifier of the sounding reference signal resource set.

27. The apparatus of claim 25, the memory and the processor further configured to cause the apparatus to:
receive, within the control message, an indication of a respective activation status for each sounding reference signal resource within the sounding reference signal resource set, the respective activation status being either activated or deactivated.

28. The apparatus of claim 25, the memory and the processor further configured to cause the apparatus to:
receive, within the control message, an indication of whether the control message is to activate or deactivate one or more sounding reference signal resources.

29. An apparatus for wireless communication, comprising:
a processor of a base station;
a transceiver coupled with the processor; and
memory coupled with the processor, the memory and the processor configured to cause the apparatus to:
transmit, via the transceiver, configuration signaling that indicates a plurality of sounding reference signal resource sets and a respective set of sounding reference signal resources within each of the plurality of sounding reference signal resource sets;
transmit, via the transceiver, a control message that indicates, for a sounding reference signal resource set of the plurality of sounding reference signal resource sets, an activation status for a sounding reference signal resource within the sounding reference signal resource set; and
receive, via the transceiver, one or more sounding reference signals based at least in part on the activation status for the sounding reference signal resource within the sounding reference signal resource set.

30. The apparatus of claim 29, the memory and the processor further configured to cause the apparatus to:
transmit, within the configuration signaling, an indication of a respective identifier for each of the plurality of sounding reference signal resource sets; and
transmit, within the control message, an indication of one or more identifiers each corresponding to a respective sounding reference signal resource set, wherein the one or more identifiers comprise an identifier of the sounding reference signal resource set.
